(19) United States
(12) Patent Application Publication
(10) Pub. No.: US 2026/0333098 A1
(43) Pub. Date: Oct. 22, 2026

(54) Feedback for Downlink Channel Configurations

(71) Applicant: Lenovo (United States) Inc., Morrisville, NC (US)

(72) Inventor: Vahid Pourahmadi, München (DE)

(73) Assignee: Lenovo (United States) Inc., Morrisville, NC (US)

(21) Appl. No.: 19/461,211

(22) Filed: Jan. 27, 2026

(51) Int. Cl. H04W 24/10; H04L 5/00

(52) U.S. Cl. CPC H04W 24/10; H04L 5/0051

(57) ABSTRACT

Various aspects of the present disclosure relate to feedback for downlink channel configurations. A user equipment (UE) receives, from a network node, a configuration for downlink transmission including a DMRS pattern for a physical downlink shared channel (PDSCH). The UE receives a PDSCH transmission including data symbols and DMRS symbols precoded using a transmit precoder. The UE estimates a downlink channel based on the DMRS symbols, wherein the downlink channel is modified by the transmit precoder. The UE transmits a feedback message including a metric indicative of suitability of the DMRS pattern for channel estimation or alignment between the transmit precoder and the downlink channel, or a recommendation to modify the DMRS pattern or CSI reporting timing.

### TECHNICAL FIELD

The present disclosure relates to wireless communications, and more specifically to feedback for downlink channel estimation and reporting.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A user equipment (UE) for wireless communication is described. The UE may be configured to, capable of, or operable to perform one or more operations as described herein. For example, the UE may be configured to, capable of, or operable to receive, from a network node, a configuration for downlink transmission, the configuration including a demodulation reference signal (DMRS) pattern for a physical downlink shared channel (PDSCH), receive, from the network node, a PDSCH transmission including data symbols and DMRS symbols precoded using a transmit precoder, estimate a downlink channel based on the DMRS symbols, where the downlink channel between the network node and the UE is modified by the transmit precoder, and transmit, based on the estimated downlink channel, a feedback message including a metric indicative of a suitability of the DMRS pattern for estimation of the downlink channel or an alignment between the transmit precoder and the downlink channel, or a recommendation to modify the DMRS pattern or a channel state information (CSI) reporting timing.

A processor (e.g., a standalone processor chipset, or a component of a UE) for wireless communication is described. The processor may be configured to, capable of, or operable to perform one or more operations as described herein. For example, the processor may be configured to, capable of, or operable to receive, from a network node, a configuration for downlink transmission, the configuration including a DMRS pattern for a PDSCH, receive, from the network node, a PDSCH transmission including data symbols and DMRS symbols precoded using a transmit precoder, estimate a downlink channel based on the DMRS symbols, where the downlink channel between the network node and the processor is modified by the transmit precoder, and transmit, based on the estimated downlink channel, a feedback message including a metric indicative of a suitability of the DMRS pattern for estimation of the downlink channel or an alignment between the transmit precoder and the downlink channel, or a recommendation to modify the DMRS pattern or a CSI reporting timing.

A method performed or performable by a UE for wireless communication is described. The method may include receiving, from a network node, a configuration for downlink transmission, the configuration including a DMRS pattern for a PDSCH, receiving, from the network node, a PDSCH transmission including data symbols and DMRS symbols precoded using a transmit precoder, estimating a downlink channel based on the DMRS symbols, where the downlink channel between the network node and the UE is modified by the transmit precoder, and transmitting, based on the estimated downlink channel, a feedback message including a metric indicative of a suitability of the DMRS pattern for estimation of the downlink channel or an alignment between the transmit precoder and the downlink channel, or a recommendation to modify the DMRS pattern or a CSI reporting timing.

In some implementations of the UE, the processor, and the method described herein, the UE receives, from the network node, a set of DMRS patterns, each DMRS pattern associated with a respective identifier, and receives, from the network node, an indication of the respective identifier corresponding to the DMRS pattern to be used for the PDSCH transmission. In some implementations of the UE, the processor, and the method described herein, the UE generates, using an artificial intelligence model, a confidence value representing an accuracy of the estimated downlink channel, where the metric indicates the confidence value. In some implementations of the UE, the processor, and the method described herein, the recommendation to modify the DMRS pattern is based on a comparison of the metric to a threshold.

In some implementations of the UE, the processor, and the method described herein, the UE measures the downlink channel at one or more REs corresponding to the DMRS symbols, interpolates the downlink channel across one or more REs of the PDSCH transmission, and computes the metric based on a difference between the interpolated downlink channel at the one or more REs of the DMRS symbols and the measured downlink channel. In some implementations of the UE, the processor, and the method described herein, the UE estimates an unprecoded downlink channel based on a CSI reference signal (CSI-RS) and determines the recommendation to modify the DMRS pattern based on channel variation characteristics of the unprecoded downlink channel. In some implementations of the UE, the processor, and the method described herein, the UE estimates the downlink channel for a first resource block (RB) and a second RB, the second RB adjacent to the first RB in time or frequency, and determines the recommendation to modify the DMRS pattern based on a variation between the downlink channel for the first RB and the downlink channel for the second RB.

In some implementations of the UE, the processor, and the method described herein, the UE computes an actual received power based on the DMRS symbols received at one or more REs of the PDSCH transmission, computes an expected received power based on an unprecoded downlink channel estimated during a CSI reporting phase and a precoder selected by the UE during the CSI reporting phase, and determines the metric based on the actual received power and the expected received power. In some implementations of the UE, the processor, and the method described herein, the recommendation to modify the CSI reporting timing is based on a difference between the actual received power and the expected received power exceeding a threshold. In some implementations of the UE, the processor, and the method described herein, the recommendation to modify the CSI reporting timing includes a recommendation to initiate an aperiodic or semi-persistent CSI report, or change a reporting period of periodic or semi-persistent CSI reporting.

In some implementations of the UE, the processor, and the method described herein, the UE estimates an unprecoded downlink channel based on a CSI-RS, computes a first downlink channel based on the unprecoded downlink channel estimated during a CSI reporting phase and a precoder selected by the UE during the CSI reporting phase, computes a second downlink channel based on the received DMRS symbols, and determines the metric based on a similarity between the first downlink channel and the second downlink channel. In some implementations of the UE, the processor, and the method described herein, the UE transmits the feedback message in response to the metric satisfying a threshold condition.

An NE (e.g., a base station) for wireless communication is described. The NE may be configured to, capable of, or operable to perform one or more operations as described herein. For example, the NE may be configured to, capable of, or operable to receive, from a UE, a CSI report including an indication of a recommended precoder based on a downlink channel estimated by the UE, transmit, to the UE, a configuration for downlink transmission, the configuration including a DMRS pattern for a PDSCH, transmit, to the UE, a PDSCH transmission including data symbols and DMRS symbols precoded using a transmit precoder, where the transmit precoder is selected based on the recommended precoder, and receive, from the UE, a feedback message including a metric indicative of a suitability of the DMRS pattern for estimation of a downlink channel or an alignment between the transmit precoder and a wireless channel between the NE and the UE, or a recommendation to modify the DMRS pattern or a CSI reporting timing.

A processor (e.g., a standalone processor chipset, or a component of an NE) for wireless communication is described. The processor may be configured to, capable of, or operable to perform one or more operations as described herein. For example, the processor may be configured to, capable of, or operable to receive, from a UE, a CSI report including an indication of a recommended precoder based on a downlink channel estimated by the UE, transmit, to the UE, a configuration for downlink transmission, the configuration including a DMRS pattern for a PDSCH, transmit, to the UE, a PDSCH transmission including data symbols and DMRS symbols precoded using a transmit precoder, where the transmit precoder is selected based on the recommended precoder, and receive, from the UE, a feedback message including a metric indicative of a suitability of the DMRS pattern for estimation of a downlink channel or an alignment between the transmit precoder and a wireless channel between the NE and the UE, or a recommendation to modify the DMRS pattern or a CSI reporting timing.

A method performed or performable by an NE for wireless communication is described. The method may include receiving, from a UE, a CSI report including an indication of a recommended precoder based on a downlink channel estimated by the UE, transmitting, to the UE, a configuration for downlink transmission, the configuration including a DMRS pattern for a PDSCH, transmitting, to the UE, a PDSCH transmission including data symbols and DMRS symbols precoded using a transmit precoder, where the transmit precoder is selected based on the recommended precoder, and receiving, from the UE, a feedback message including a metric indicative of a suitability of the DMRS pattern for estimation of a downlink channel or an alignment between the transmit precoder and a wireless channel between the NE and the UE, or a recommendation to modify the DMRS pattern or a CSI reporting timing.

In some implementations of the NE, the processor, and the method described herein, the recommendation to modify the CSI reporting timing includes initiating an aperiodic or semi-persistent CSI report, or changing a reporting period of periodic or semi-persistent CSI reporting. In some implementations of the NE, the processor, and the method described herein, the recommendation to modify the DMRS pattern includes a recommendation to increase a density of the DMRS symbols in the DMRS pattern, decrease the density of the DMRS symbols in the DMRS pattern, or select a different DMRS pattern from a set of DMRS patterns.

In some implementations of the NE, the processor, and the method described herein, the NE transmits, to the UE, an indication of an updated DMRS pattern in a downlink control information (DCI) message. In some implementations of the NE, the processor, and the method described herein, the NE transmits, to the UE, a set of DMRS patterns, each DMRS pattern associated with a respective identifier, where the indication of the updated DMRS pattern includes the respective identifier corresponding to the updated DMRS pattern. In some implementations of the NE, the processor, and the method described herein, the CSI report indicates one or more eigenvalues associated with the recommended precoder.

### BRIEF DESCRIPTION OF THE DRAWINGS

FIG. 1 illustrates an example of a wireless communications system in accordance with aspects of the present disclosure.

FIGS. 2A through 2C illustrate examples of channel estimation block diagrams, in accordance with aspects of the present disclosure.

FIG. 3 illustrates an example signaling diagram, in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

A wireless communications system includes one or more devices (e.g., UEs and NEs) configured to exchange signaling for downlink data transmission. For example, in 5G NR systems, a network node (e.g., a gNB or base station) and a UE utilize defined reference signals, such as DMRS, CSI-RS, and the like, for beamforming and data transmission. The network node transmits CSI-RS on a downlink channel periodically or on-demand. CSI-RS may include reference symbols that enable the UE to measure downlink channel conditions. CSI-RS may be configured in various patterns (e.g., utilizing different resources including time domain resources, frequency domain resources, and/or spatial domain resources such as antenna ports) and may be transmitted periodically or semi-persistently, or may be aperiodically triggered via downlink control information (DCI). The UE determines the time and frequency location of CSI-RS based on higher-layer (e.g., RRC) configurations.

Upon receiving CSI-RS, the UE estimates the channel and computes CSI feedback parameters. These parameters may include a rank indicator (RI) indicating a preferred number of multiple-input multiple-output (MIMO) layers, a precoding matrix indicator (PMI) indicating an index of a preferred precoding or beamforming vector from a codebook, and a channel quality indicator (CQI) indicating a modulation and coding scheme (MCS) supportable by the channel at a target error rate. These CSI parameters represent the downlink channel as measured by the UE. The UE transmits the CSI report to the network node via an uplink control channel (e.g., a physical uplink control channel (PUCCH)) for periodic reports or via a scheduled uplink shared channel (e.g., PUSCH) for aperiodic reports. The network node utilizes the received CSI to schedule and adapt downlink transmissions, such as by selecting beamforming parameters, a quantity of layers, a modulation order, and/or a coding rate for data transmissions to the UE.

When the network node has data to transmit, the network node schedules a PDSCH transmission. Based on the CSI, the network node selects a precoding matrix (e.g., a beamforming vector or matrix) to direct the transmission toward the UE based on the channel's direction. The data is encoded and mapped onto modulation symbols and subsequently precoded. The precoded symbols are mapped to resource elements (REs) (e.g., time-frequency grid positions) allocated for the PDSCH. The network node inserts DMRS into the PDSCH time-frequency allocation along with the data. DMRS serve as pilot signals that enable the UE to estimate the channel by comparing received symbols to known transmitted sequences. As used herein, the term “pilot” refers to a reference signal, such as DMRS, that is known to both the transmitter and receiver and used for channel estimation. DMRS are precoded using the same precoder as the data such that the UE's channel estimate on the DMRS reflects the effective channel including the effects of the precoding. The pattern of DMRS (e.g., the time symbols and subcarriers utilized for DMRS), referred to herein as a DMRS pattern, is configured by the network node via RRC signaling and indicated via DCI for dynamic toggling.

The UE receives the PDSCH and extracts the DMRS symbols on the preconfigured REs. Using the extracted DMRS symbols, the UE performs channel estimation, such as by using a least-squares or minimum mean square error (MMSE) estimator across the DMRS REs to interpolate the channel's frequency response. Since the DMRS undergo the same precoding as the data, the UE can obtain an estimation of an effective channel by interpolating channel estimates from DMRS REs across time and frequency. For example, the UE may estimate the effective channel as the product of the precoding matrix applied by the network node and a matrix representing the channel (e.g., the physical channel), referred to herein as the physical channel matrix. The effective channel represents the end-to-end channel observed by the UE, which includes the effects of both the physical propagation channel between the network node antennas and the UE antennas and the precoding applied by the network node to the transmitted signals. The UE does not have explicit knowledge of the precoding matrix, but treats the DMRS as originating from virtual antennas that account for precoding. This estimate is utilized by the UE to equalize the received PDSCH data symbols and decode the transmitted information. If the transmission is successful, the UE transmits an acknowledgement (ACK) to the network node; if decoding fails (e.g., due to packet error), the UE transmits a negative acknowledgement (NACK), prompting a retransmission.

Reliability of a downlink transmission chain depends primarily on three factors: signal quality (e.g., signal-to-noise ratio (SNR), signal-to-interference-plus-noise ratio (SINR)) of the channel, which may be affected by path loss, fading, interference, and the like; the accuracy of the UE's channel estimation, which depends on the DMRS pilot design (including DMRS density and pattern) and the estimation algorithm; and the alignment between the network node's precoder and the actual channel. If any of these factors are suboptimal, downlink throughput and reliability degrade. For instance, for a channel with a high SNR, a DMRS pattern that is too sparse may result in estimation error and cause the UE to decode data incorrectly. Alternatively, if the SNR is high and the DMRS estimation is accurate, but the network node's selected precoder is misaligned with the current channel (e.g., because the UE changed locations or characteristics of the channel changed after the last CSI report), the effective gain observed by the UE may decrease, causing errors.

The 5G NR design assumes the above feedback loop operates with a defined periodicity and fixed overhead margins. The rate at which the UE transmits CSI feedback reports may be relatively low (e.g., once every tens of milliseconds (ms)) and the DMRS overhead is fixed to provide channel tracking. The network node relies on the UE's periodic CSI to adjust beamforming, and on a fixed DMRS pattern to enable channel estimation. No fast or direct feedback mechanism exists from the UE other than the CSI reports and ACK/NACK messages. Thus, the UE cannot indicate to the network node that the channel has changed or that the DMRS pattern is too conservative or too sparse except by failing to decode (e.g., by transmitting NACK) or, in extreme cases, triggering a beam failure indicator.

In 5G NR, two limitations in existing downlink operations result in suboptimal performance. First, the density and pattern of DMRS are configured semi-statically and remain fixed during transmissions. For example, a configuration for PDSCH DMRS in a full slot transmission (referred to as mapping type A) may include a pilot pattern having one DMRS symbol at slot symbol 2, and optionally a second DMRS at slot symbol 11 (e.g., if an additional pilot is configured for high Doppler scenarios) in every RB. This pilot pattern is designed to cover low to moderate mobility scenarios. If the pilot pattern is not selected correctly, the pilot pattern either causes unnecessary overhead or insufficient accuracy depending on actual channel conditions. For example, if a UE is in a slow-varying channel, using a dense frequency pattern (e.g., two DMRS symbols) increases resource consumption and overhead without providing additional benefit. However, the network node is unable to dynamically reduce the DMRS because the UE has no mechanism to indicate as such to the network node. In such scenarios, the DMRS overhead can be up to approximately 4% of REs. The same issue exists if a UE is in a fast-varying channel but configured with a fixed pilot pattern that is too sparse. As the network node has no direct or real-time feedback about channel estimation quality at the UE, the DMRS configuration remains static during a session (unless reconfigured via RRC or preset rules for certain transmission types). No dynamic inner loop exists to change pilot density based on actual need, which may result in wasted overhead or insufficient channel sampling.

Second, the CSI feedback loop has inherent latency and coarseness. Currently, the network node determines appropriate timing for CSI reports. For periodic CSI, the periodicity may be every 20 ms; for aperiodic CSI, the network node may trigger a report when certain conditions are met (e.g., a timer expires or a significant event occurs). A UE may report a PMI based on a CSI-RS measurement, but by the time the network node uses that PMI for precoding (even a few milliseconds later), the channel may have rotated to a different state (especially in high Doppler scenarios or at millimeter wave (mmW) frequencies). Additionally, CSI reports with PMI, CQI, and/or RI indications result in overhead, and the network node may not initiate a new report if the network node is attempting to conserve uplink overhead. Moreover, the UE has no mechanism to indicate that its recommended precoder (e.g., indicated in the CSI report) is outdated. If the network node continues using an outdated precoder, the effect is beamforming misalignment: the transmitted signal no longer arrives at the UE with the optimal phase/amplitude combination across antennas, resulting in reduced SINR. This manifests as throughput reduction or decoding failures.

In current systems, indications to the network node of CSI becoming stale are indirect. For example, the network node may detect the block error rate rising (e.g., as NACKs are increasingly received) or the achieved throughput falling below what the last CQI predicted. As a reaction, the network node may then trigger an aperiodic CSI request (e.g., via a PDCCH command) or reduce the modulation order. However, by the time this occurs, performance has already degraded. Moreover, a high NACK rate does not explicitly indicate to the network node the root cause; the root cause could be interference, noise rise, or precoder misalignment. Mechanisms such as outer loop link adaptation (OLLA) exist where the network node adjusts its interpretation of CQI based on actual error outcomes (e.g., to converge to a target BLER). Additionally, or alternatively, if the channel changes such that the beam is lost, a beam failure recovery (BFR) procedure can be initiated where the UE signals a beam failure after missing certain reference signals, prompting the network node to switch beams or initiate connection re-establishment. However, such mechanisms are slow adaptations and do not provide fine-grained feedback about whether the current precoder/beam direction is still optimal for the UE's current position and channel conditions.

The combined effect of these limitations is that the downlink operates suboptimally in certain scenarios. With fixed configuration and fixed overhead, the network node may tune itself for worst-case conditions, thereby reducing spectral efficiency. Additionally, when channel conditions change, the network node is unable to react in a time-sensitive manner or implement fine-grained adjustments, causing throughput reduction. The UE is well-positioned to assess the quality of the channel estimation and the validity of the precoder, but in current 5G NR systems, the UE cannot directly inform the network node of these aspects, as no mechanism exists to dynamically change the DMRS pattern based on the UE's real-time observation.

Accordingly, the techniques described herein provide a UE-driven feedback mechanism for adaptation of DMRS patterns and CSI reporting timing. The UE estimates the effective downlink channel based on received DMRS symbols and determines a metric indicative of a suitability of the DMRS pattern for channel estimation, or indicative of an alignment between the precoder used by the network node and the current channel. The UE transmits a feedback message to the network node that includes the metric and/or a recommendation to modify the DMRS pattern or CSI reporting timing. In some examples, the metric may include a confidence value that represents uncertainty in the channel estimation. Additionally, or alternatively, the UE may compute the metric based on a comparison between measured channel values at DMRS REs and interpolated channel values, or based on a comparison between an actual received power at DMRS REs and an expected received power computed using the channel estimated during CSI-RS measurement and the precoder recommended by the UE. Based on the feedback message, the network node may dynamically adapt the DMRS pattern or density for subsequent transmissions or initiate another round of CSI reporting to obtain updated precoder recommendations.

The described techniques provide improvements in communications performance by enabling closed-loop adaptation between the UE and the network node for DMRS pattern selection and CSI reporting timing. By providing direct feedback regarding channel estimation quality and precoder alignment, the UE enables the network node to distinguish between causes of degraded performance, such as insufficient DMRS density, channel aging, or precoder mismatch. The network node may increase DMRS density when the UE indicates low confidence in channel estimation, decrease DMRS density when the UE indicates high confidence to reduce overhead, or initiate CSI reporting when the UE indicates precoder misalignment. These techniques may improve spectral efficiency by avoiding unnecessary DMRS overhead when channel conditions are favorable, improve reliability by increasing DMRS density when channel conditions are challenging, and reduce latency in responding to channel changes by providing direct feedback rather than relying on indirect indicators such as NACK rates.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

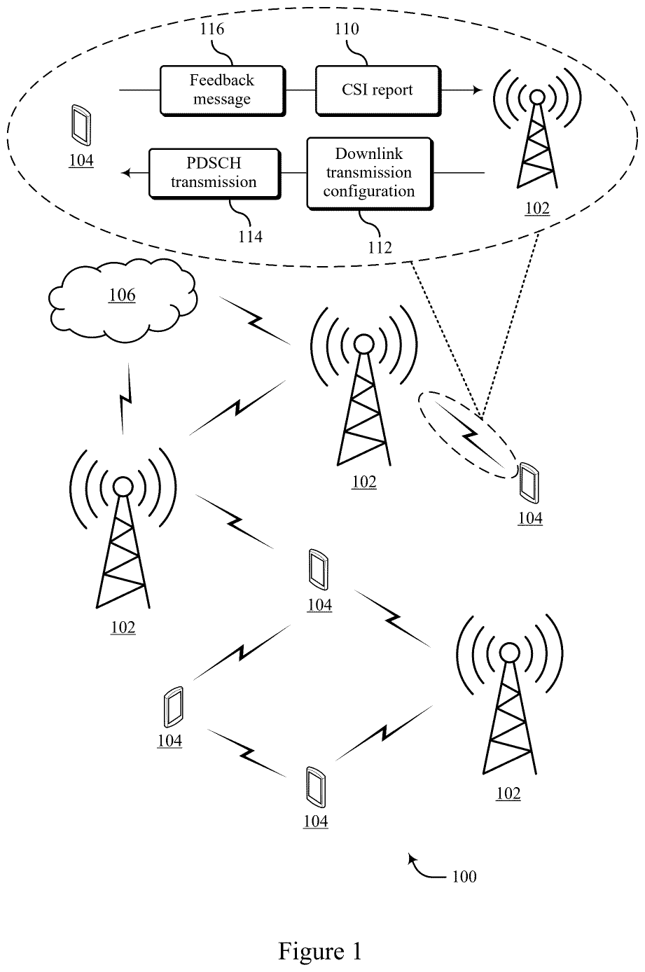

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

DMRS are reference signals transmitted on the same time-frequency resources as the PDSCH and are used by the UE 104 for channel estimation and demodulation. In NR systems, DMRS are user-specific and present only when data is scheduled, in contrast to cell-wide reference signals used in other RATs. DMRS may be precoded along with the data symbols, and DMRS for multiple UEs 104 are orthogonal by design using different sequences or ports to avoid interference, thereby enabling multi-user MIMO (MU-MIMO) support. The PDSCH DMRS design supports up to 12 orthogonal layers (ports).

The time-frequency pattern of DMRS for PDSCH is configured by higher-layer parameters, such as RRC signaling. A DMRS configuration may include a mapping type, where mapping type A is slot-aligned and mapping type B allows PDSCH to start at a position other than the beginning of the slot. The configuration may also include a DMRS configuration type, where type 1 DMRS uses a pattern occupying every second subcarrier in the allocated RB and supports up to 8 DMRS ports, and type 2 DMRS uses a denser pattern occupying every third pair of subcarriers and supports up to 12 orthogonal DMRS ports. The configuration may further include a quantity of DMRS symbols. For instance, DMRS may span one or two OFDM symbols in the slot. The NE 102 may configure up to three additional DMRS symbols in the slot beyond a first DMRS symbol to increase pilot time density for high Doppler scenarios. DMRS are generated from pseudo-random sequences known to both the NE 102 and the UE 104.

The NE 102 may convey the DMRS configuration to the UE 104 via RRC signaling. The DMRS configuration may indicate, for example, a DMRS type (e.g., DMRS type=1), a maximum length (e.g., maxLength=1 for a single symbol), an additional position parameter (e.g., additionalPosition=pos1 (meaning allow a second DMRS symbol)), a mapping type (e.g., mappingType=A), and a DMRS position (e.g., dmrs-TypeA-pos=2). Each PDSCH assignment via DCI may include a field indicating whether an additional DMRS position is used for that transmission and which DMRS sequence initializations are to be used. If the DCI does not indicate otherwise, the UE 104 assumes a default pattern. The NE 102 may toggle on or off an additional DMRS symbol in each slot via a field in the DCI, but changing the DMRS pattern to introduce a new pilot position may require RRC reconfiguration.

Conventional channel estimation at the UE 104 involves measuring the received DMRS at the corresponding REs and comparing them to known transmitted sequences. A least-squares (LS) estimate of the effective channel on the DMRS REs may be computed as shown in Equation 1 below:

$${h}_{eff} \{ pilot \} = \frac{y \{ DMRS \}}{x \{ DMRS \}} \qquad ( 1 )$$

In Equation 1, x{DMRS} represents the known DMRS sequence symbols and y{DMRS} represents the received signal at the DMRS REs. These estimates are obtained at the specific REs where DMRS are transmitted. The UE 104 then interpolates the channel estimates to obtain channel values for data-carrying REs, for example, using an LS or linear minimum mean square error (LMMSE) estimator. The accuracy of the interpolation depends on pilot spacing, where larger gaps between pilots may result in increased interpolation error if the channel varies within the gaps. For example, if a channel has a coherence time shorter than a slot length, a single pilot at the beginning of the slot may be insufficient for accurate channel estimation.

Conventional DMRS configurations are characterized by static allocation. Once configured, the DMRS pattern remains fixed until reconfigured via RRC signaling. If the NE 102 configures a single DMRS symbol and the UE 104 subsequently experiences fast fading conditions, the UE 104 may experience decoding failures until the configuration is modified. No feedback mechanism exists for the UE 104 to indicate to the NE 102 that pilot density adjustment is warranted. The NE 102 sets DMRS parameters during connection establishment based on UE capability or mobility class and adjusts parameters on a relatively slow timescale. Due to the static nature of DMRS configuration, systems may default to using additional DMRS symbols to ensure reliability, resulting in reduced throughput due to increased overhead.

Additionally, no direct feedback mechanism exists from the UE 104 regarding channel estimation quality. CSI reports from the UE 104 pertain to channel direction and quality for precoding selection, not the sufficiency of pilot patterns or the alignment between the applied precoder and the current channel. The NE 102 may indirectly infer channel estimation quality based on decoding failures indicated by NACKs from the UE 104.

CSI in NR encompasses feedback components that inform transmission parameters at the NE 102. CSI reports may include an RI, a PMI, and/or a CQI. An RI is an integer indicating a preferred number of layers for data transmission, determined by the UE 104 based on channel eigenvalue assessment. A PMI indicates a precoding vector or matrix from a codebook, which is computed by the UE 104 based on downlink channel estimation from CSI-RS. A CQI corresponds to a recommended MCS that the current channel can support under a target BLER, and is generated by the UE 104 assuming the NE 102 will use the reported PMI and RI. CSI reports may optionally include additional information such as a layer indicator (LI), a CSI-RS resource indicator (CRI), or PMI phase and amplitude adjustments for Type II codebooks.

CSI reporting includes three modes. Periodic CSI reporting involves the UE 104 transmitting CSI at a regular interval on an uplink control channel, configured via RRC signaling with a periodicity and offset. Aperiodic CSI reporting is triggered on-demand by the NE 102 via a CSI request field in a downlink scheduling grant or DCI, whereupon the UE 104 measures on configured CSI-RS and transmits CSI feedback on an uplink channel. Semi-persistent CSI reporting is periodic CSI reporting activated after an indication from the NE 102.

In conventional CSI reporting, the NE 102 determines when CSI is requested, except for periodic reports transmitted according to a configured schedule. If channel conditions change between reports, the UE 104 cannot autonomously transmit a CSI update earlier than the scheduled time. If the NE 102 does not trigger an aperiodic report and the periodicity of periodic reports is long, a window exists during which the NE 102 uses outdated channel information.

In single-user MIMO (SU-MIMO), the NE 102 may use the PMI reported by the UE 104 for downlink transmission. However, the NE 102 is not required to use the reported PMI. In MU-MIMO, the NE 102 may select precoders that represent a compromise to minimize interference among multiple UEs 104, resulting in a precoder that differs from the precoder reported (e.g., recommended, indicated) by a given UE 104. The UE 104 is not explicitly informed of the difference between the reported precoder and the applied precoder; rather, the UE 104 receives DMRS ports and infers the effective channel based on the received DMRS symbols.

Precoder mismatch, where the current downlink channel and the precoding matrix used by the NE 102 are not aligned, may occur for several reasons: the precoder selected by the NE 102 due to other constraints (e.g., compromise among multiple UEs) may not be suited for the channel; the PMI reported by the UE 104 may have limited accuracy due to channel estimation error or codebook quantization; or time may have passed since the last CSI report such that the channel has changed and the precoder is no longer optimal for the current channel.

Conventional systems include strategies to address CSI aging and precoder mismatch, but all rely on indirect indicators (and thereby introduce inaccuracies) or introduce additional overhead. Configuring frequent CSI reports maintains current channel information but consumes uplink resources and UE battery. Adaptive triggering, where the NE 102 triggers additional CSI reports based on heuristics such as handover completion, beam switch, or mobility patterns, is network-driven and based on indirect indicators. In time division duplex (TDD) mode, the NE 102 may use uplink sounding reference signals (SRS) from the UE 104 to estimate the downlink channel based on channel reciprocity, though this approach is not applicable in frequency division duplex (FDD) mode or when SRS transmissions are infrequent. OLLA adjusts the assumed CQI based on acknowledgment statistics. Beam failure recovery allows the UE 104 to declare a beam failure and request a new beam if the link degrades to the point where the UE 104 cannot decode downlink control or reference signals, though this mechanism results in service interruption.

Conventional systems provide building blocks for CSI reporting and DMRS configuration but lack closed-loop adaptivity between the UE 104 and the NE 102 for dynamic adjustment of these parameters. Aperiodic CSI reporting allows the NE 102 to trigger additional reports on demand, but as mentioned above, such triggers are based on observations at the NE 102 such as NACK statistics rather than explicit indications from the UE 104. Approaches to dynamic DMRS configuration, where the NE 102 adapts DMRS patterns based on reported CQI and measured BLER, rely on coarse metrics and do not incorporate the UE 104's channel estimation confidence.

Machine learning techniques have been explored for CSI feedback compression, channel prediction, and uncertainty estimation for channel prediction. Beam management procedures in NR allow the UE 104 to measure beams and report measurements such as reference signal received power (RSRP) and to indicate when a current beam is weakening via beam failure recovery. Research has explored optimizing pilot patterns using machine learning and deep learning-based channel estimators that provide uncertainty measures along with channel estimates. However, these conventional methods and research directions also fail to provide a mechanism for the UE 104 to signal the need for DMRS or CSI adjustments based on the UE 104's observation of channel estimation quality and precoder alignment.

The techniques described herein address these limitations by introducing a feedback mechanism that enables the UE 104 to provide direct indications to the NE 102 regarding channel estimation quality and precoder alignment. In the wireless communications system 100, a UE 104 transmits a CSI report 110 to an NE 102. The CSI report 110 may indicate a transmit precoder recommended by the UE 104, e.g., for use by the NE 102 in subsequent communications. The UE 104 receives, from the NE 102 via a wireless channel, a downlink transmission configuration 112 including a DMRS pattern for a PDSCH transmission 114. The NE 102 transmits the PDSCH transmission to the UE 104 including data symbols and DMRS symbols precoded using a transmit precoder, which may or may not be the same as the transmit precoder indicated in the CSI report 110.

The UE 104 estimates a downlink channel based on the received DMRS symbols. The downlink channel represents the wireless channel between the NE 102 and the UE 104 as precoded by the transmit precoder. Based on the estimated downlink channel, the UE 104 determines a metric indicating a suitability of the DMRS pattern for estimation of the downlink channel and/or indicating an alignment between the transmit precoder and the wireless channel. The UE 104 transmits a feedback message 116 to the NE 102 that indicates the metric and/or a recommendation to modify the DMRS pattern or a timing of CSI reporting. Upon receiving the feedback message, the NE 102 may dynamically adapt one or more parameters based on the metric and/or the recommendation(s). For example, the NE 102 may modify the DMRS pattern for subsequent transmissions, such as by increasing or decreasing a density of DMRS symbols or selecting a different DMRS pattern. Alternatively or additionally, the NE 102 may modify the CSI reporting timing, such as by initiating an aperiodic CSI report or changing a reporting period of periodic CSI reporting.

The feedback mechanism described herein addresses the deficiencies of conventional systems by providing a direct, real-time indication from the UE 104 to the NE 102 regarding channel estimation quality and precoder alignment. Unlike conventional approaches where the NE 102 infers performance degradation indirectly through NACK rates or BLER statistics, the described techniques enable the UE 104 to actively signal when the DMRS pattern is insufficient for accurate channel estimation or when the applied precoder is misaligned with the current channel. This closed-loop feedback enables the NE 102 to respond to changing channel conditions with reduced latency, to distinguish between causes of degraded performance, and to dynamically adjust DMRS density based on actual channel estimation quality rather than worst-case assumptions.

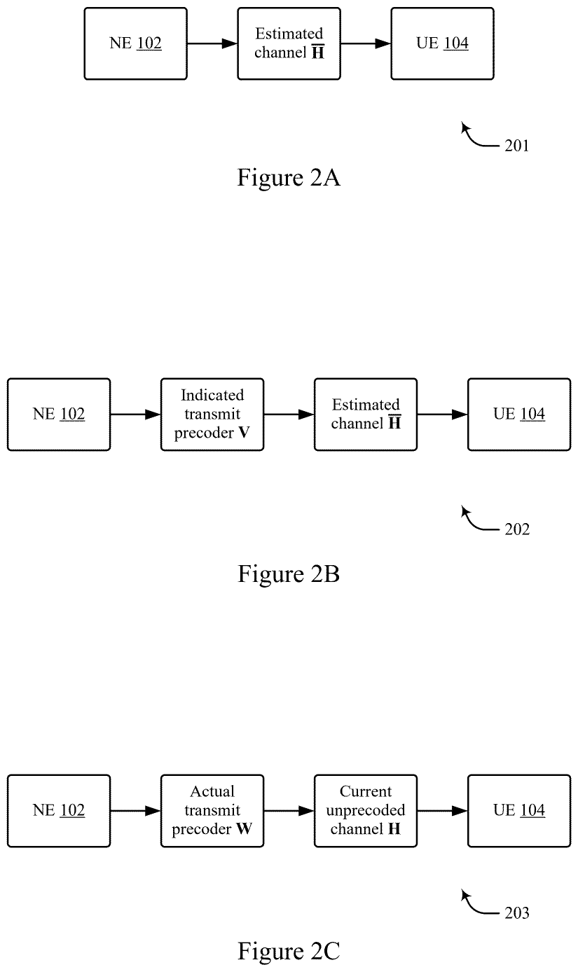

FIGS. 2A, 2B, and 2C illustrate examples of channel estimation block diagrams 201, 202, and 203, respectively, in accordance with aspects of the present disclosure. In some examples, the channel estimation block diagrams 201, 202, and 203 implement or are implemented by aspects of the wireless communications system 100. For example, the channel estimation block diagrams 201, 202, and 203 may implement or be implemented by an NE 102 and a UE 104, which may be examples of the corresponding devices as described with reference to FIG. 1.

The channel estimation block diagrams 201, 202, and 203 represent different perspectives of a downlink channel between the UE 104 and the NE 102. The channel estimation block diagram 201 illustrates an unprecoded channel H̅ estimated by the UE 104 during the CSI-RS phase, e.g,. based on measuring CSI-RS received from the NE 102. The channel estimation block diagram 202 illustrates an expected effective channel estimated by the UE 104 upon reception of a PDSCH transmision including DMRS. In this example, the UE 104 assumes that the NE 102 used a UE-indicated transmit precoder V_{L} to transmit the PDSCH transmission, and that the channel has not changed since the CSI-RS phase. The UE 104 estimates the downlink channel as the unprecoded channel H̅ (from the CSI-RS phase channel estimation) modified by the transmit precoder V_{L}. The channel estimation block diagram 203 illustrates an actual effective channel H estimated by the UE 104 using the DMRS received from the NE 102.

Traditional channel estimation in wireless systems relies on DMRS pilot signals. For example, the UE 104 receives, via the downlink channel between the UE 104 and the NE 102, a PDSCH transmission from the NE 102 and identifies included DMRS REs. The UE 104 estimates channel coefficients for the downlink channel at those REs using known sequences of the DMRS and interpolates or extrapolates to obtain channel estimates for data-carrying REs of the PDSCH transmission. The UE 104 may utilize LS estimation, LMMSE estimation, Kalman filtering, and/or one or more AI models to perform the channel estimation. This channel estimation may be referred to as measurement-based effective channel estimation. The estimated channel is the effective channel between the streams of data and the receive antennas at the UE 104. As described with reference to FIG. 1, the effective channel can be found using Equation 1.

The effectiveness of a DMRS configuration depends on DMRS pattern density and channel dynamics. As used herein, the density of the DMRS pattern refers to the number of DMRS symbols in the time domain and the number of DMRS subcarriers in the frequency domain within a RB (e.g., of the PDSCH transmission). The DMRS pattern density may also be referred to as a pilot density. If the channel varies slowly in frequency relative to pilot spacing, a sparse pilot grid (i.e., DMRS pattern) may be sufficient. If the channel varies rapidly in frequency due to frequency-selective fading, a denser pilot grid or a more sophisticated interpolator may be required. If the channel varies slowly in time due to low Doppler, a single pilot symbol per slot may suffice. If the channel varies rapidly in time due to high UE mobility, multiple DMRS symbols per slot may be needed to sample the channel at different times for interpolation.

The techniques described herein enable the UE 104 to perform measurements and estimates during both a CSI-RS phase and a DMRS phase, and to compute metrics based on comparisons between expected and actual channel conditions. During the CSI-RS phase, the UE 104 estimates an unprecoded downlink channel based on a received CSI-RS and determines a recommended precoder. The UE 104 transmits a CSI report to the NE 102 during the CSI phase based on this channel estimation, where the CSI report includes an indication of a transmit precoder recommended (e.g., preferred) by the UE 104. The indication of the transmit precoder may include or be an example of a PMI that points to a precoding matrix or vector within a predefined codebook based on the UE 104's channel measurements. During the DMRS phase, the UE 104 uses received DMRS to estimate the downlink channel as precoded by the transmit precoder applied by the NE 102.

Based on these estimates, the UE 104 determines a metric indicative of a suitability of the DMRS pattern for estimation of the downlink channel and/or a metric indicative of an alignment between the transmit precoder and the wireless channel. The UE 104 transmits a feedback message to the NE 102 indicating the metric. Additionally, or alternatively, the UE 104 may indicate, in the feedback message, a recommendation to modify the DMRS pattern or a CSI reporting timing. The UE 104 may transmit the feedback message periodically or only when the UE 104 determines that the current DMRS pattern or density is inappropriate. Upon receiving the feedback message, the NE 102 may adapt the DMRS pattern for subsequent transmissions or initiate another round of CSI reporting to obtain updated precoder recommendations from the UE 104.

In the example of FIG. 2A, the NE 102 transmits CSI-RS to the UE 104 over an unprecoded downlink channel. The UE 104 estimates the unprecoded channel H̅, which is an m×n complex matrix representing a complex channel gain between n transmit antennas at the NE 102 and m receive antennas at the UE 104. Based on the estimated unprecoded channel H̅, the UE 104 determines a recommended precoder using singular value decomposition (SVD). The SVD decomposition of the estimated channel may be expressed as H̅=UΣV^{H} where V contains the right singular vectors that form the basis for the recommended precoder V_{L}. That is, the UE 104 selects precoding vectors V_{L}=[v₁, v₂, . . . , v_{L}], where vᵢ represents the precoding vector of size n×1 associated with the i^{th} layer, and L is the number of layers. The UE 104 transmits a CSI report to the NE 102 including an indication (e.g., PMI) of the recommended precoder V_{L}. In some implementations, the UE 104 also reports the eigenvalues σᵢ associated with each precoding vector along with the PMI (e.g., as part of the CSI report).

In the example of FIG. 2B, the UE 104 has received a PDSCH transmission including DMRS symbols and data symbols from the NE 102. The UE 104 assumes that the NE 102 used the indicated transmit precoder to transmit the PDSCH transmission. Additionally, the UE 104 assumes that the downlink channel has not changed since the CSI-RS phase, and as such estimates the downlink channel using the estimated unprecoded channel H and the indicated transmit precoder V_{L}. This channel estimation may be referred to as an expected effective channel H̅V_{L} that the UE 104 would observe if the channel remained unchanged from the CSI reporting phase and the NE 102 applied the recommended precoder.

Based on the expected effective channel, the UE 104 may compute an expected received power over the DMRS REs. Assuming x_{DMRS} represents the symbols transmitted over the DMRS REs and y_{DMRS} represents the expected received signal at the DMRS REs, the expected received power ζ̅_{DMRS} may be computed using Equation 2 below.

$${\overline{ζ}}_{D M R S} = {\overline{y}}_{D M R S}^{H} {\overline{y}}_{D M R S} = {( \overline{H} {V}_{L} {x}_{D M R S} )}^{H} \times ( \overline{H} {V}_{L} {x}_{D M R S} ) \qquad ( 2 )$$

In the example of FIG. 2C, the UE 104 estimates an actual effective channel HW_{L}, also referred to as a combined effective channel, where H is the current unprecoded channel and W_{L} is the actual transmit precoder (i.e., precoding matrix) applied by the NE 102. The precoding matrix applied by the NE 102 may be represented as W_{L}=[p₁, p₂, . . . , p_{L}], where pᵢ represents the precoding vector of size n×1 associated with the i^{th} layer. The applied precoder pᵢ may be different from the precoder vᵢ recommended by the UE 104 as part of the CSI report. Additionally, the current unprecoded channel H may be different from the unprecoded channel H̅ estimated during the CSI-RS phase due to channel aging. While the UE 104 does not have access to the current channel H and the applied precoder W_{L} separately, the UE 104 is able to determine the combined effective channel HW_{L}. Additionally, the received signal at the UE 104 may be expressed as y=HWx where x is of size L×1 for each RE, representing the data for each layer.

Based on the actual effective channel, the UE 104 may compute an actual received power over the DMRS REs. The actual received power ζ_{DMRS} may be computed using Equation 3 below.

$${ζ}_{D M R S} = {y}_{DMRS}^{H} {y}_{DMRS} = {( H {W}_{L} {x}_{D M R S} )}^{H} \times ( H {W}_{L} {x}_{D M R S} ) \qquad ( 3 )$$

The UE 104 may compare metrics derived from the expected effective channel of FIG. 2B and the actual effective channel of FIG. 2C to determine an alignment between the precoder used by the NE 102 and the current channel conditions. As used herein, the alignment between the transmit precoder and a channel refers to how well the precoder selected by the NE 102 matches current channel conditions. A well-aligned precoder directs the transmitted signal in a spatial direction that corresponds to the current channel characteristics, such that the transmitted signal arrives at the UE 104 with optimal phase and amplitude combinations across antennas. Misalignment between the transmit precoder and the wireless channel results in reduced signal quality at the UE 104.

According to the techniques described herein, after receiving the PDSCH transmission including the DMRS symbols, the UE 104 estimates the effective channel and generates at least one metric indicating whether the current downlink transmission configuration is appropriate for the channel conditions observed by the UE 104. The metric represents the reliability of the channel estimate(s) and the effectiveness of the current transmission parameters, including the DMRS configuration and the transmit precoder used by the NE 102. That is, the metric reflects the performance of the current DMRS pattern and the transmit precoder relative to the actual channel conditions. In some examples, the metric includes or is an example of the channel estimation values calculated by the UE 104. Additionally, or alternatively, the metric includes or is an example of a Ratio or difference between one or more metrics computed by the UE 104. Additionally, or alternatively, the metric includes or is an example of a confidence value indicative of a quality or accuracy of the channel estimation performed by the UE 104. The confidence value indicates the degree to which the UE 104 is confident in the accuracy of the estimated channel, reflecting whether the DMRS pattern provided sufficient information for reliable channel estimation under the current channel conditions.

The UE 104 transmits a feedback message (e.g., the feedback message 116) to the NE 102 including an indication of the metric. Upon receiving the feedback message, the NE 102 may use the metric to determine whether to modify the DMRS pattern for subsequent transmissions, initiate an aperiodic CSI report to obtain updated precoder recommendations, or adjust other transmission parameters based on the indicated channel estimation quality or precoder alignment.

In one implementation, to generate the metric, the UE 104 uses an AI model that takes the measurement-based effective channel estimation at the DMRS REs as input and produces an estimation of the effective channel across all REs as output. As another output, the AI model may generate a confidence value representing how confident the AI model is about the estimated effective channel. Additionally, or alternatively, the AI model may directly determine (e.g., output) whether the DMRS pattern or density is appropriate or requires modification.

In another implementation, instead of an AI model, the UE 104 estimates the effective channel for all REs using conventional approaches, such as LS or LMMSE interpolation. The UE 104 then uses the estimated effective channel and the measured channel over the DMRS REs to generate a confidence value and/or to directly determine whether the DMRS pattern or density is appropriate or requires modification. In some examples, to generate the confidence value, the UE 104 computes a mean of the difference between the output of the interpolation at the REs associated with the DMRS and the measurement-based effective channel estimation at those REs. A lower mean difference represents higher confidence, and a higher mean difference represents lower confidence.

The metric (and/or a value of the metric) may indicate whether the density of the DMRS is sufficient, insufficient, or whether the NE 102 may reduce the DMRS density. A metric indicating sufficient DMRS density suggests that the current pilot configuration provides adequate channel estimation accuracy for reliable data demodulation. A metric indicating insufficient DMRS density suggests that the current pilot configuration does not provide enough reference signals for the UE 104 to accurately estimate the channel, which may result in interpolation errors and degraded demodulation performance. A metric indicating that the NE 102 may reduce the DMRS density suggests that the current pilot configuration provides more reference signals than necessary for the current channel conditions, and reducing the DMRS density would decrease overhead without significantly impacting channel estimation accuracy.

The metric may be expressed as a numerical score or a categorical indication. For example, the confidence value may be a continuous or discrete value within a defined range, such as a value between 0 and 1, where values closer to 1 indicate higher confidence in the channel estimation accuracy and values closer to 0 indicate lower confidence. A numerical score may represent a quantized representation of the channel estimation quality or precoder alignment, such as an index into a predefined table of quality levels. A categorical indication may be a discrete label or index that directly indicates one of the three states: sufficient DMRS density, insufficient DMRS density, or excessive DMRS density (i.e., DMRS density may be reduced). The categorical indication may be encoded using a small number of bits, such as two bits to represent the three states, thereby reducing uplink overhead for the feedback message. In some implementations, the metric may include multiple components, such as the confidence value for channel estimation quality and a separate indication for precoder alignment, enabling the NE 102 to distinguish between causes of degraded performance and take appropriate corrective action.

The UE 104 may transmit the at least one metric to the NE 102, and the NE 102 may use the at least one metric to increase or decrease the density of the DMRS pattern accordingly. Alternatively, the UE 104 may use the metric to generate a recommendation to increase or decrease the DMRS density or to select a different DMRS pattern, and the UE 104 may transmit the recommendation to the NE 102. In some examples, the NE 102 or the UE 104 may suggest changing the DMRS pattern to a pattern with lower overhead in response to a higher confidence value.

In some examples, after estimating the effective channel, the UE 104 analyzes the effective channel to determine an appropriate DMRS pattern or density and compares the determined pattern or density against the pattern or density currently used by the NE 102. If a significant difference is detected, the UE 104 transmits a recommendation to the NE 102 to adjust the DMRS pattern or to trigger CSI reporting. For example, if the UE 104 observes large variations in the frequency domain of the estimated effective channel but the NE 102 used a DMRS configuration with lower frequency density, the UE 104 may recommend that the NE 102 use a DMRS configuration with higher frequency density.

In another implementation, the UE 104 considers the effective channel estimated over different RBs or adjacent time slots and compares the changes in the estimated channel between them to determine whether the original DMRS pattern or density was sufficient. For example, if the estimated effective channel between two adjacent time slots is changing considerably but the NE 102 did not use additional DMRS positions, the UE 104 may conclude that the coherence time of the channel is small and recommend a pattern with additional DMRS positions.

The coherence time of the channel refers to the time duration over which the channel impulse response remains substantially correlated. When the coherence time is shorter than the slot duration, the channel may vary significantly within a single slot, and a single DMRS symbol at the beginning of the slot may not provide sufficient information for accurate channel estimation throughout the slot. In such scenarios, additional DMRS positions distributed across the slot enable the UE 104 to track the time-varying channel more accurately by providing multiple sampling points of the channel state.

Similarly, the UE 104 may compare the estimated effective channel across adjacent RBs in the frequency domain to assess the coherence bandwidth of the channel. The coherence bandwidth refers to the frequency range over which the channel frequency response remains substantially correlated. If the UE 104 observes large variations in the estimated effective channel between adjacent RBs in frequency, the UE 104 may conclude that the channel exhibits frequency-selective fading with a coherence bandwidth smaller than the RB bandwidth. In this case, the UE 104 may recommend a DMRS pattern with higher frequency density, such as DMRS configuration type 1 which occupies every second subcarrier, rather than DMRS configuration type 2 which uses a sparser frequency pattern.

The UE 104 may also base the recommendation for DMRS pattern or density on the channel measured during the CSI-RS phase, which is the unprecoded channel. This unprecoded channel estimation provides the UE 104 with information about the channel characteristics, including frequency selectivity and time variability, before any precoding is applied. The UE 104 may analyze the estimated unprecoded channel to determine channel variation characteristics that inform the appropriate DMRS pattern for subsequent PDSCH transmissions.

For example, if the UE 104 observes that the estimated unprecoded channel exhibits significant variation across subcarriers in the frequency domain, indicating frequency-selective fading with a coherence bandwidth smaller than the RB bandwidth, the UE 104 may recommend a DMRS pattern with higher frequency density. In such scenarios, a DMRS configuration type 1, which occupies every second subcarrier in the allocated RB, may provide more accurate channel estimation than a DMRS configuration type 2, which uses a sparser frequency pattern. Conversely, if the estimated unprecoded channel exhibits relatively flat frequency response across the bandwidth, the UE 104 may recommend a DMRS pattern with lower frequency density to reduce overhead without significantly impacting channel estimation accuracy.

Similarly, if the UE 104 observes that the estimated unprecoded channel exhibits significant variation over time, indicating high Doppler spread due to UE mobility or environmental changes, the UE 104 may recommend a DMRS pattern with additional DMRS positions distributed across the slot. The additional DMRS symbols enable the UE 104 to track the time-varying channel more accurately by providing multiple sampling points of the channel state within a single slot. Conversely, if the estimated unprecoded channel exhibits slow time variation, indicating low Doppler conditions, the UE 104 may recommend a DMRS pattern with fewer DMRS symbols to reduce overhead.

The UE 104 may determine the channel variation characteristics by computing statistical measures of the estimated unprecoded channel, such as the variance of channel coefficients across frequency or time, the delay spread estimated from the frequency-domain channel response, or the Doppler spread estimated from time-domain channel variations. Based on these statistical measures, the UE 104 may select a recommended DMRS pattern from a set of available patterns or may indicate specific parameters such as the DMRS configuration type, the number of DMRS symbols, or the additional DMRS positions.

The techniques described above provide an indication that the DMRS pattern or density may need modification. However, in some cases, although there are sufficient DMRS REs, the UE 104 may still experience low performance due to the transmit precoder selected by the NE 102. Thus, in some examples, the UE 104 may determine one or more metrics indicative of the quality of the transmit precoder, e.g., indicative of the alignment between the transmit precoder and the downlink channel. For example, the UE 104 may compare the received signal power over the DMRS REs with what the UE 104 would expect to receive if the NE 102 had used the precoder recommended by the UE 104 and the channel measured during the CSI-RS phase. The UE 104 may compute the actual received power ζ_{DMRS} over the DMRS REs and compare it to the expected received power ζ̅_{DMRS}. In some implementations, the UE 104 computes the ratio or difference between ζ_{DMRS} and ζ̅_{DMRS} and reports the ratio or difference to the NE 102. This metric may represent a potential gain by adjusting the transmission parameters.

In some examples, the UE 104 determines that the precoder is misaligned with the current channel or that the channel has aged since the CSI-RS phase based on a comparison of the actual received power ζ_{DMRS} and the expected received power ζ̅_{DMRS}. When the difference between the actual received power and the expected received power exceeds a threshold, the UE 104 may recommend that the NE 102 modify the CSI reporting timing. For example, the UE 104 may recommend that the NE 102 initiate an aperiodic CSI report or increase the frequency of periodic CSI reporting to obtain updated channel information and precoder recommendations. This enables the UE 104 to proactively signal to the NE 102 that updated channel state information is needed, rather than waiting for the NE 102 to infer this condition from indirect indicators such as NACK rates.

In another implementation, the UE 104 may compute a similarity metric between the effective channel for each layer based on measurements obtained during the CSI-RS phase and the DMRS phase. For the i^{th} layer having a recommended precoder vᵢ and an actual applied precoder pᵢ, the similarity metric Ei may be computed according to Equation 4 below.

εᵢ=(H̅vᵢ)^{H}(Hpᵢ) (4)

The current channel may be expressed as H=H̅+ΔH, where ΔH represents the channel variation between the CSI-RS phase and the DMRS phase. In implementations wherein the UE 104 determines the recommended precoder based on SVD decomposition of the estimated channel H̅, the decomposition may be expressed as H̅=UΣV^{H}. The applied precoder pᵢ may be represented as a linear combination of the UE-recommended precoders, as shown in Equation 5.

pᵢ=Σⱼαⱼvⱼ (5)

Upon substitution of these expressions, the similarity metric may be expanded as shown in Equation 6.

$$( 6 )$$

$${ε}_{i} = {σ}_{i} {u}_{i}^{H} ( \overline{H} {\sum }_{j} {α}_{j} {v}_{j} + Δ H {\sum }_{j} {α}_{j} {v}_{j} ) = {α}_{i} {σ}_{i}^{2} + {\sum }_{j} {σ}_{i} {α}_{j} {u}_{i}^{H} Δ {Hv}_{j}$$

In the case wherein the NE 102 selects pᵢ to be equivalent to vᵢ and the channel remains unchanged between the CSI-RS phase and the current channel measurement, εᵢ is equal to

$${α}_{i} {σ}_{i}^{2} .$$

Channel variation or channel estimation error manifests as a deviation in εᵢ. However, because the UE 104 does not have knowledge of the applied precoder pᵢ, the UE 104 is unable to distinguish between the effect of channel variation and the effect of mismatch between pᵢ and vᵢ, represented by αᵢ.

Although εᵢ is functionally related to ΔH, the presence of the first term precludes the UE 104 from determining a course of action based solely on the value of εᵢ. Accordingly, the UE 104 may compute εᵢ for each layer and transmit the computed values to the NE 102, e.g., as part of the feedback message.

In some implementations, during the CSI reporting phase, the UE 104 transmits, in addition to the recommended PMI (vᵢ), the eigenvalue σᵢ associated with each recommended precoder. Based on this information, and because the NE 102 has access to pᵢ, the NE 102 may compute

$${σ}_{i}^{2} \times {v}_{i}^{H} \times {p}_{i} = {α}_{i} {σ}_{i}^{2} .$$

The NE 102 may then isolate the term

$${\sum }_{j} {σ}_{i} {α}_{j} {u}_{i}^{H} Δ H {v}_{j} ,$$

based on which the NE 102 may determine whether a substantial channel variation has occurred and initiate a subsequent round of CSI reporting, or whether the NE 102 should configure a different DMRS pattern to facilitate improved channel estimation during PDSCH data transmission.

The UE 104 may transmit the feedback message to the NE 102 periodically or in response to a trigger condition being satisfied. In some examples, the UE 104 transmits the feedback message in response to the metric satisfying a threshold condition, such as when the confidence value falls below a predetermined threshold (indicating that the DMRS pattern provides insufficient reference signals for accurate channel estimation) or when the confidence value exceeds the threshold (indicating that the DMRS density could be reduced to decrease overhead). As another example, the trigger condition may be a difference between the actual received power and the expected received power exceeding a threshold, indicating precoder misalignment or channel aging. In other examples, the UE 104 transmits the feedback message in response to detecting a significant difference between an appropriate DMRS pattern determined by the UE 104 and the DMRS pattern currently used by the NE 102. In yet other examples, the UE 104 transmits the feedback message in response to observing large variations in the estimated effective channel between adjacent RBs or time slots, or in response to observing large variations in the frequency or time domain of the unprecoded channel estimated using CSI-RS. Event-based transmission of the feedback message reduces uplink overhead while enabling the NE 102 to respond to changing channel conditions.

The feedback message may include a value of the metric, such as the confidence value or the similarity metric εᵢ. Additionally, or alternatively, the feedback message may include a recommendation to modify the DMRS pattern and/or a recommendation to modify a timing of a CSI report (e.g., when the UE 104 determines that the precoder is no longer aligned with the current channel conditions). The recommendation to modify the DMRS pattern may include, for example, an indication to increase the density of the DMRS symbols in the DMRS pattern, an indication to decrease the density of the DMRS symbols in the DMRS pattern, or an indication to select a different DMRS pattern from a set of DMRS patterns. In the latter example, the UE 104 may indicate a particular DMRS pattern (e.g., via a corresponding index) or may indicate that the DMRS pattern should be changed. The recommendation to modify the timing of the CSI report may include an indication to initiate a CSI report (e.g., an aperiodic or a semi-persistent CSI report) and/or to change a reporting period of a periodic CSI report configuration.

The feedback message may include multiple indications, such as one or more metrics, one or more recommendations, or a combination thereof. For example, the UE 104 may transmit both a confidence value and a recommendation to modify the DMRS pattern within the same feedback message. The UE 104 may transmit the feedback message via a MAC-CE or uplink control information. Because the feedback is configured to enable dynamic adaptation, RRC signaling may be unsuitable for transmitting the feedback message due to latency constraints.

Upon receiving the metric(s) and/or the recommendation(s) from the UE 104, the NE 102 may identify a cause of degraded performance and take appropriate action. Multiple conditions may result in ζ_{DMRS} being less than the expected ζ̅_{DMRS}. In a first case, the NE 102 may have selected a precoding vector that differs from the precoding vector indicated by the UE 104 based on operational constraints, such as multi-user MIMO scheduling requirements. In this case, the NE 102 anticipates reduced performance with the applied precoder W and may maintain the current parameters and precoder configuration notwithstanding the metric indicating suboptimal performance.

In a second case, the degraded performance may be attributable to insufficient accuracy in the channel estimation during estimation of H̅ or H. To address this condition, the NE 102 may initiate a subsequent CSI-RS procedure with the UE 104 to obtain an updated recommended precoder based on improved channel estimation at the UE 104, or the NE 102 may configure a different DMRS pattern to facilitate improved channel estimation at the UE 104. In a third case, the channel may have undergone substantial variation between the time at which the UE 104 performed channel measurement during the CSI-RS phase for determining the recommended precoder and the time at which the NE 102 utilized that information to determine the transmit precoder for data transmission. Upon determining this condition, the NE 102 may initiate a subsequent round of CSI reporting to obtain current channel state information for precoder selection.

In response to determining to modify the DMRS pattern across different RBs or slots, the NE 102 transmits signaling indicating the modification to the UE 104. Due to the requirement for rapid adaptation, transmission of reconfiguration messages via RRC signaling may be unsuitable as reduced latency indication of the DMRS pattern modification may be required.

In conventional systems, DMRS is configured per bandwidth part and remains fixed. When the UE 104 is scheduled at that bandwidth part, the UE 104 utilizes the configured DMRS pattern. In contrast, the techniques described herein enable multiple DMRS patterns to be preconfigured at the UE 104. During a configuration phase, the NE 102 configures the UE 104 with a plurality of DMRS patterns (e.g., via RRC signaling), each DMRS pattern associated with a respective identifier. During PDSCH transmission, the NE 102 transmits (e.g., via DCI) an indication of the identifier corresponding to the DMRS pattern used for the PDSCH transmission. The UE 104 utilizes the identifier to determine the REs carrying the DMRS for channel estimation. Upon receiving the feedback message, the NE 102 may determine to update or otherwise modify the DMRS pattern. Consequently, the NE 102 may transmit (e.g., via DCI), to the UE 104, an indication of an identifier corresponding to the updated DMRS pattern. This approach enables rapid adaptation of the DMRS pattern without requiring RRC reconfiguration.

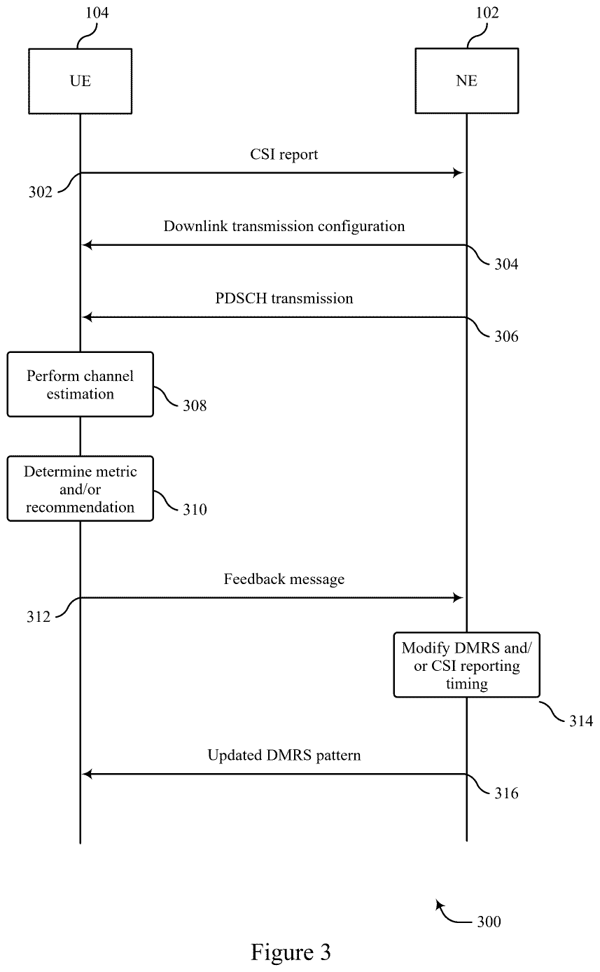

FIG. 3 illustrates an example of a signaling diagram 300 in accordance with aspects of the present disclosure. In some examples, the signaling diagram 300 implements or is implemented by aspects of the wireless communications system 100 and/or the channel estimation block diagrams 201-203. The signaling diagram 300 may implement or be implemented by an NE 102 and a UE 104, which may be examples of the corresponding devices as described with reference to FIGS. 1 and 2. Alternative examples of the following may be implemented, where some processes are performed in a different order than described or are not performed. In some cases, processes may include additional features not mentioned below, or further processes may be added.

At 302, the UE 104 transmits, and the NE 102 receives, a CSI report (e.g., the CSI report 110 as described with reference to FIG. 1). The CSI report includes CSI determined by the UE 104 based on a downlink channel (e.g., between the NE 102 and the UE 104) estimated by the UE 104. For example, the UE 104 may estimate an unprecoded downlink channelH H based on a CSI-RS transmitted by the NE 102, as described with reference to FIG. 2A. The CSI report includes an indication of a recommended precoder V_{L}=[v₁, v₂, . . . , v_{L}] determined by the UE 104 based on the estimated unprecoded downlink channel. In some cases, the CSI report indicates one or more eigenvalues σᵢ associated with the recommended precoder. The eigenvalues may be used by the NE 102 to separate the effects of channel change from precoder mismatch when processing feedback from the UE 104.

At 304, the NE 102 transmits a downlink transmission configuration (e.g., the downlink transmission configuration 112 as described with reference to FIG. 1) to the UE 104. The downlink transmission configuration may include or be an example of an RRC message and includes a DMRS pattern for a PDSCH. The DMRS pattern defines the time-frequency positions of DMRS symbols within the PDSCH allocation. In some examples, as part of the downlink transmission configuration, the NE 102 transmits a set of DMRS patterns to the UE 104, each DMRS pattern associated with a respective identifier. In some cases, the NE 102 transmits an indication of the respective identifier corresponding to the DMRS pattern to be used for the PDSCH transmission, for example via a DCI message.

At 306, the NE 102 transmits a PDSCH transmission (e.g., the PDSCH transmission 114 as described with reference to FIG. 1) via the downlink channel to the UE 104. The PDSCH transmission includes data symbols and DMRS symbols precoded using a transmit precoder. The transmit precoder is selected by the NE 102 based on the recommended precoder indicated in the CSI report. In some cases, the transmit precoder W_{L}=[p₁, p₂, . . . , p_{L}] applied by the NE 102 may differ from the recommended precoder V_{L}[v₁, v₂, . . . , V_{L}] due to constraints such as MU-MIMO scheduling. In other cases, the transmit precoder Wl is the same as the recommended precoder Vl.

At 308, the UE 104 performs channel estimation as described with reference to FIGS. 2A through 2C. The UE 104 estimates the downlink channel by performing measurements on the DMRS symbols received according to the DMRS pattern. In some examples, the UE 104 measures the downlink channel at REs corresponding to the DMRS symbols and interpolates the downlink channel across REs of the PDSCH transmission to obtain channel estimates for data-carrying REs.

At 310, the UE 104 determines one or more metrics and/or one or more recommendations (e.g., based on the one or more metrics). The metric(s) may be indicative of a suitability of the DMRS pattern for estimation of the downlink channel and/or an alignment between the transmit precoder and the downlink channel. The recommendation to modify the DMRS pattern may include a recommendation to increase a density of the DMRS symbols in the DMRS pattern, decrease the density of the DMRS symbols in the DMRS pattern, or select a different DMRS pattern from a set of DMRS patterns. The recommendation to modify the CSI reporting timing may include a recommendation to initiate an aperiodic or semi-persistent CSI report or change a reporting period of periodic or semi-persistent CSI reporting.

In some examples, the metric includes or is an example of a confidence value representing an accuracy of the estimated downlink channel, where the metric indicates the confidence value. In some cases, the UE 104 computes the metric based on a difference between the interpolated downlink channel at the one or more REs of the DMRS symbols and the measured downlink channel. A lower mean difference represents higher confidence in the channel estimation, and a higher mean difference represents lower confidence. Additionally, or alternatively, the UE 104 may estimate the downlink channel for a first RB and a second RB, the second RB adjacent to the first RB in time or frequency, and determine a recommendation to modify the DMRS pattern based on a variation between the downlink channel for the first RB and the downlink channel for the second RB.

As described with reference to FIG. 2C, the UE 104 may estimate the effective channel HW_{L}, which represents the combined effect of the current wireless channel H and the applied transmit precoder W_{L}. Based on the estimated effective channel, the UE 104 may compute an actual received power ζ_{DMRS} over the DMRS REs. As described with reference to FIG. 2B, the UE 104 may additionally or alternatively compute an expected received power ζ_{DMRS} based on the unprecoded downlink channel H and the precoder V_{L} recommended by the UE 104 during the CSI reporting phase. Additionally, or alternatively the UE 104 may compute a first effective channel H̅vᵢ based on the unprecoded downlink channel and the recommended precoder and a second effective channel Hpᵢ based on the received DMRS symbols, for use in computing a similarity metric εᵢ.

In some cases, the UE 104 computes the similarity metric εᵢ between a first downlink channel and a second downlink channel. The first downlink channel is computed based on the unprecoded downlink channel estimated during the CSI reporting phase and the precoder selected by the UE 104 during the CSI reporting phase, corresponding to the expected effective channel H̅vᵢ as described with reference to FIG. 2B. The second downlink channel is computed based on the received DMRS symbols, corresponding to the actual effective channel Hpᵢ as described with reference to FIG. 2C.

The UE 104 may determine a recommendation to modify the DMRS pattern based on a comparison of the metric to a threshold. In some examples, the UE 104 estimates an unprecoded downlink channel based on a CSI-RS and determines the recommendation to modify the DMRS pattern based on channel variation characteristics of the unprecoded downlink channel. For example, if the UE 104 observes large variations in the frequency or time domain of the channel estimated using CSI-RS, the UE 104 may recommend DMRS patterns with higher densities.

At 312, the UE 104 transmits a feedback message (e.g., the feedback message 116 as described with reference to FIG. 1) to the NE 102. The feedback message includes the one or more metrics and/or the one or more recommendations. In some examples, the feedback message includes a value of the metric, such as the confidence value or the similarity metric εᵢ. In some cases, the feedback message indicates an identifier corresponding to a recommended DMRS pattern. Additionally, or alternatively, the feedback message includes a recommendation to trigger a CSI report or otherwise modify a timing of a CSI reporting configuration.

In some examples, the UE 104 transmits the feedback message in response to the metric satisfying a threshold condition. For example, the UE 104 may transmit the feedback message in response to the confidence value satisfying (or failing to satisfy) a threshold, and/or based on a difference between the actual received power and the expected received power exceeding a threshold. The UE 104 may transmit the feedback message via a MAC-CE or via uplink control information.

At 314, the NE 102 modifies the DMRS and/or CSI reporting timing in response to the feedback message received from the UE 104. For example, the NE 102 may implement the recommendation indicated in the feedback message, such as by initiating a CSI report or implementing the recommended modifications to the DMRS configuration. In some examples, the NE 102 dynamically updates the DMRS pattern or density for subsequent downlink transmissions to the UE 104. The NE 102 may use the metric value in combination with historical BLER statistics to select an appropriate DMRS pattern.

In some examples, when the NE 102 receives the similarity metric εᵢ from the UE 104 and the CSI report 110 indicated the eigenvalues σᵢ associated with the recommended precoder, the NE 102 may compute

$${α}_{i} {σ}_{i}^{2} = {σ}_{i}^{2} \times {v}_{i}^{H} \times {p}_{i}$$

based on the applied precoder pᵢ and the recommended precoder vᵢ. The NE 102 may then separate the term

$${\sum }_{j} {σ}_{i} {α}_{j} {u}_{i}^{H} Δ H {v}_{j}$$

from the reported similarity metric to determine whether there is a considerable shift in the channel ΔH. Based on this determination, the NE 102 may start another round of CSI reporting or select another DMRS pattern to enhance channel estimation during PDSCH data transmission.

At 316, the NE 102 transmits (e.g., as part of DCI) an indication of the updated DMRS pattern to the UE 104. If the UE 104 is preconfigured with a set of DMRS patterns at 304, the indication of the updated DMRS pattern includes the respective identifier corresponding to the updated DMRS pattern. This approach enables rapid adaptation of the DMRS pattern without requiring RRC reconfiguration. The updated DMRS pattern reflects the adaptation performed by the NE 102 in response to the feedback message, enabling improved channel estimation or reduced overhead for subsequent PDSCH transmissions.

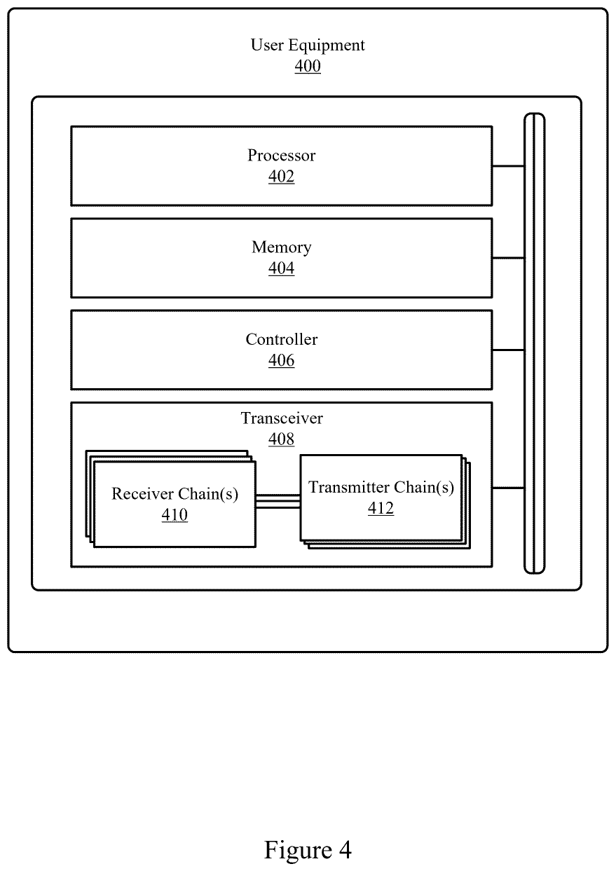

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a central processing unit (CPU), an ASIC, a field-programmable gate-array (FPGA), or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving, from a network node, a configuration for downlink transmission, the configuration including a DMRS pattern for a PDSCH, receiving, from the network node, a PDSCH transmission including data symbols and DMRS symbols precoded using a transmit precoder, estimating a downlink channel based on the DMRS symbols, where the downlink channel between the network node and the UE is modified by the transmit precoder, and transmitting, based on the estimated downlink channel, a feedback message including at least one of a metric indicative of at least one of a suitability of the DMRS pattern for estimation of the downlink channel or an alignment between the transmit precoder and the downlink channel, or a recommendation to modify at least one of the DMRS pattern or a CSI reporting timing. In this manner, the UE 400 enables closed-loop adaptation of DMRS patterns and CSI reporting timing by providing direct feedback to the network node regarding channel estimation quality and precoder alignment.

Additionally, or alternatively, the UE 400 may be configured to support any one or combination of receiving, from the network node, a set of DMRS patterns, each DMRS pattern associated with a respective identifier, and receiving, from the network node, an indication of the respective identifier corresponding to the DMRS pattern to be used for the PDSCH transmission. This aspect enables rapid adaptation of the DMRS pattern without requiring RRC reconfiguration by allowing the network node to signal a pattern change via an identifier. Additionally, or alternatively, the UE 400 may be configured to support any one or combination of generating, using an artificial intelligence model, a confidence value representing an accuracy of the estimated downlink channel, where the metric indicates the confidence value. This aspect enables the UE 400 to provide a quantitative indication of channel estimation reliability to the network node.

Additionally, or alternatively, the UE 400 may be configured to support any one or combination of determining the recommendation to modify the DMRS pattern based on a comparison of the metric to a threshold. This aspect enables the UE 400 to trigger DMRS pattern modifications when channel estimation quality falls outside acceptable bounds. Additionally, or alternatively, the UE 400 may be configured to support any one or combination of measuring the downlink channel at one or more REs corresponding to the DMRS symbols, interpolating the downlink channel across one or more REs of the PDSCH transmission, and computing the metric based on a difference between the interpolated downlink channel at the one or more REs of the DMRS symbols and the measured downlink channel. This aspect enables the UE 400 to assess channel estimation accuracy using conventional estimation techniques without requiring an artificial intelligence model.

Additionally, or alternatively, the UE 400 may be configured to support any one or combination of estimating an unprecoded downlink channel based on a CSI-RS and determining the recommendation to modify the DMRS pattern based on channel variation characteristics of the unprecoded downlink channel. This aspect enables the UE 400 to recommend DMRS patterns suited to the observed channel conditions based on frequency or time domain variations. Additionally, or alternatively, the UE 400 may be configured to support any one or combination of estimating the downlink channel for a first RB and a second RB, the second RB adjacent to the first RB in time or frequency, and determining the recommendation to modify the DMRS pattern based on a variation between the downlink channel for the first RB and the downlink channel for the second RB. This aspect enables the UE 400 to detect rapid channel variations and recommend increased DMRS density when the coherence time or coherence bandwidth of the channel is small.

Additionally, or alternatively, the UE 400 may be configured to support any one or combination of computing an actual received power based on the DMRS symbols received at one or more REs of the PDSCH transmission, computing an expected received power based on an unprecoded downlink channel estimated during a CSI reporting phase and a precoder selected by the UE during the CSI reporting phase, and determining the metric based on the actual received power and the expected received power. This aspect enables the UE 400 to assess precoder alignment by comparing observed performance against expected performance. Additionally, or alternatively, the UE 400 may be configured to support any one or combination of determining the recommendation to modify the CSI reporting timing based on a difference between the actual received power and the expected received power exceeding a threshold. This aspect enables the UE 400 to trigger CSI reporting when precoder mismatch is detected. Additionally, or alternatively, the UE 400 may be configured to support any one or combination of determining the recommendation to modify the CSI reporting timing including a recommendation to at least one of initiate an aperiodic or semi-persistent CSI report or change a reporting period of periodic or semi-persistent CSI reporting. This aspect enables the UE 400 to request updated channel information from the network node when the current precoder is outdated.

Additionally, or alternatively, the UE 400 may be configured to support any one or combination of estimating an unprecoded downlink channel based on a CSI-RS, computing a first downlink channel based on the unprecoded downlink channel estimated during a CSI reporting phase and a precoder selected by the UE during the CSI reporting phase, computing a second downlink channel based on the received DMRS symbols, and determining the metric based on a similarity between the first downlink channel and the second downlink channel. This aspect enables the UE 400 to compute a similarity metric that indicates the degree of alignment between the expected effective channel and the actual effective channel. Additionally, or alternatively, the UE 400 may be configured to support any one or combination of transmitting the feedback message in response to the metric satisfying a threshold condition. This aspect enables event-based transmission of the feedback message to reduce uplink overhead while still enabling the network node to respond to changing channel conditions.

Additionally, or alternatively, the UE 400 may support at least one memory (e.g., the memory 404) and at least one processor (e.g., the processor 402) coupled with the at least one memory and configured to cause the UE 400 to receive, from a network node, a configuration for downlink transmission, the configuration including a DMRS pattern for a PDSCH, receive, from the network node, a PDSCH transmission including data symbols and DMRS symbols precoded using a transmit precoder, estimate a downlink channel based on the DMRS symbols, where the downlink channel between the network node and the UE is modified by the transmit precoder, and transmit, based on the estimated downlink channel, a feedback message including at least one of a metric indicative of at least one of a suitability of the DMRS pattern for estimation of the downlink channel or an alignment between the transmit precoder and the downlink channel, or a recommendation to modify at least one of the DMRS pattern or a CSI reporting timing. In this manner, the UE 400 provides direct feedback to the network node to enable dynamic adaptation of DMRS patterns and CSI reporting timing based on observed channel conditions.

Additionally, or alternatively, the UE 400 may be configured to support any one or combination of receiving, from the network node, a set of DMRS patterns, each DMRS pattern associated with a respective identifier, and receiving, from the network node, an indication of the respective identifier corresponding to the DMRS pattern to be used for the PDSCH transmission. This aspect enables the network node to signal DMRS pattern changes via DCI without requiring RRC reconfiguration. Additionally, or alternatively, the UE 400 may be configured to support any one or combination of generating, using an artificial intelligence model, a confidence value representing an accuracy of the estimated downlink channel, where the metric indicates the confidence value. This aspect enables the UE 400 to leverage machine learning techniques to quantify channel estimation uncertainty.

Additionally, or alternatively, the UE 400 may be configured to support any one or combination of determining the recommendation to modify the DMRS pattern based on a comparison of the metric to a threshold. This aspect enables threshold-based triggering of DMRS pattern adaptation. Additionally, or alternatively, the UE 400 may be configured to support any one or combination of measuring the downlink channel at one or more REs corresponding to the DMRS symbols, interpolating the downlink channel across one or more REs of the PDSCH transmission, and computing the metric based on a difference between the interpolated downlink channel at the one or more REs of the DMRS symbols and the measured downlink channel. This aspect enables the UE 400 to compute a confidence metric using conventional channel estimation techniques.

Additionally, or alternatively, the UE 400 may be configured to support any one or combination of estimating an unprecoded downlink channel based on a CSI-RS and determining the recommendation to modify the DMRS pattern based on channel variation characteristics of the unprecoded downlink channel. This aspect enables the UE 400 to base DMRS pattern recommendations on observed channel statistics. Additionally, or alternatively, the UE 400 may be configured to support any one or combination of estimating the downlink channel for a first RB and a second RB, the second RB adjacent to the first RB in time or frequency, and determining the recommendation to modify the DMRS pattern based on a variation between the downlink channel for the first RB and the downlink channel for the second RB. This aspect enables the UE 400 to detect channel variations across adjacent RBs and recommend appropriate DMRS density.

Additionally, or alternatively, the UE 400 may be configured to support any one or combination of computing an actual received power based on the DMRS symbols received at one or more REs of the PDSCH transmission, computing an expected received power based on an unprecoded downlink channel estimated during a CSI reporting phase and a precoder selected by the UE during the CSI reporting phase, and determining the metric based on the actual received power and the expected received power. This aspect enables the UE 400 to quantify the degree of precoder mismatch or channel aging. Additionally, or alternatively, the UE 400 may be configured to support any one or combination of determining the recommendation to modify the CSI reporting timing based on a difference between the actual received power and the expected received power exceeding a threshold. This aspect enables the UE 400 to trigger CSI reporting when the difference between actual and expected performance indicates precoder misalignment.

Additionally, or alternatively, the UE 400 may be configured to support any one or combination of determining the recommendation to modify the CSI reporting timing including a recommendation to at least one of initiate an aperiodic or semi-persistent CSI report or change a reporting period of periodic or semi-persistent CSI reporting. This aspect enables the UE 400 to request updated precoder recommendations from the network node. Additionally, or alternatively, the UE 400 may be configured to support any one or combination of estimating an unprecoded downlink channel based on a CSI-RS, computing a first downlink channel based on the unprecoded downlink channel estimated during a CSI reporting phase and a precoder selected by the UE during the CSI reporting phase, computing a second downlink channel based on the received DMRS symbols, and determining the metric based on a similarity between the first downlink channel and the second downlink channel. This aspect enables the UE 400 to compute a similarity metric that the network node may use to distinguish between channel aging and precoder mismatch. Additionally, or alternatively, the UE 400 may be configured to support any one or combination of transmitting the feedback message in response to the metric satisfying a threshold condition. This aspect enables the UE 400 to reduce uplink overhead by transmitting feedback only when adaptation is warranted.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

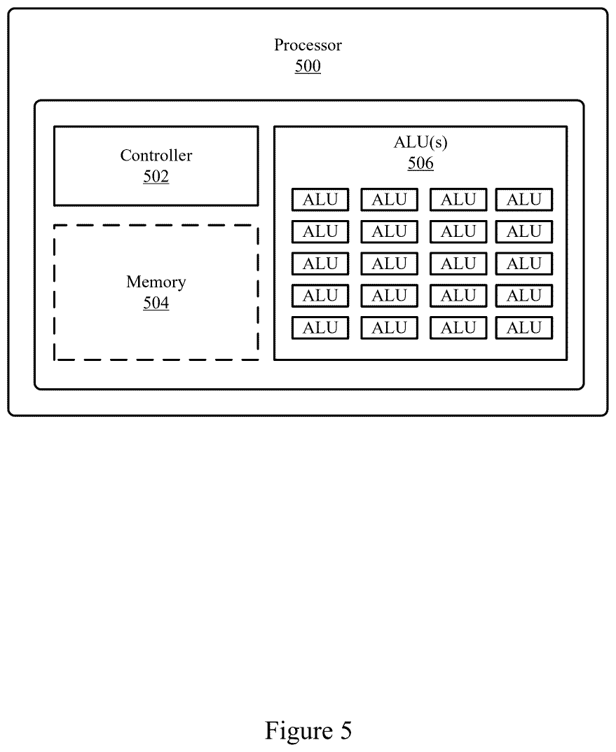

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support at least one controller (e.g., the controller 502) coupled with at least one memory (e.g., the memory 504) and configured to cause the processor to receive, from a network node, a configuration for downlink transmission, the configuration including a DMRS pattern for a PDSCH, receive, from the network node, a PDSCH transmission including data symbols and DMRS symbols precoded using a transmit precoder, estimate a downlink channel based on the DMRS symbols, where the downlink channel between the network node and the UE is modified by the transmit precoder, and transmit, based on the estimated downlink channel, a feedback message including a metric indicative of a suitability of the DMRS pattern for estimation of the downlink channel or an alignment between the transmit precoder and the downlink channel, or a recommendation to modify the DMRS pattern or a CSI reporting timing. In this manner, the processor 500 enables closed-loop adaptation of DMRS patterns and CSI reporting timing by providing direct feedback to the network node regarding channel estimation quality and precoder alignment.

Additionally, or alternatively, the processor 500 may be configured to or operable to support any one or combination of receiving, from the network node, a set of DMRS patterns, each DMRS pattern associated with a respective identifier, and receiving, from the network node, an indication of the respective identifier corresponding to the DMRS pattern to be used for the PDSCH transmission. This aspect enables rapid adaptation of the DMRS pattern without requiring RRC reconfiguration by allowing the network node to signal a pattern change via an identifier. Additionally, or alternatively, the processor 500 may be configured to or operable to support any one or combination of generating, using an artificial intelligence model, a confidence value representing an accuracy of the estimated downlink channel, where the metric indicates the confidence value. This aspect enables the processor 500 to provide a quantitative indication of channel estimation reliability to the network node.

Additionally, or alternatively, the processor 500 may be configured to or operable to support any one or combination of determining the recommendation to modify the DMRS pattern based on a comparison of the metric to a threshold. This aspect enables the processor 500 to trigger DMRS pattern modifications when channel estimation quality falls outside acceptable bounds. Additionally, or alternatively, the processor 500 may be configured to or operable to support any one or combination of measuring the downlink channel at one or more REs corresponding to the DMRS symbols, interpolating the downlink channel across one or more REs of the PDSCH transmission, and computing the metric based on a difference between the interpolated downlink channel at the one or more REs of the DMRS symbols and the measured downlink channel. This aspect enables the processor 500 to assess channel estimation accuracy using conventional estimation techniques without requiring an artificial intelligence model.

Additionally, or alternatively, the processor 500 may be configured to or operable to support any one or combination of estimating an unprecoded downlink channel based on a CSI-RS and determining the recommendation to modify the DMRS pattern based on channel variation characteristics of the unprecoded downlink channel. This aspect enables the processor 500 to recommend DMRS patterns suited to the observed channel conditions based on frequency or time domain variations. Additionally, or alternatively, the processor 500 may be configured to or operable to support any one or combination of estimating the downlink channel for a first RB and a second RB, the second RB adjacent to the first RB in time or frequency, and determining the recommendation to modify the DMRS pattern based on a variation between the downlink channel for the first RB and the downlink channel for the second RB. This aspect enables the processor 500 to detect rapid channel variations and recommend increased DMRS density when the coherence time or coherence bandwidth of the channel is small.

Additionally, or alternatively, the processor 500 may be configured to or operable to support any one or combination of computing an actual received power based on the DMRS symbols received at one or more REs of the PDSCH transmission, computing an expected received power based on an unprecoded downlink channel estimated during a CSI reporting phase and a precoder selected by the UE during the CSI reporting phase, and determining the metric based on the actual received power and the expected received power. This aspect enables the processor 500 to assess precoder alignment by comparing observed performance against expected performance. Additionally, or alternatively, the processor 500 may be configured to or operable to support any one or combination of determining the recommendation to modify the CSI reporting timing based on a difference between the actual received power and the expected received power exceeding a threshold. This aspect enables the processor 500 to trigger CSI reporting when precoder mismatch is detected.

Additionally, or alternatively, the processor 500 may be configured to or operable to support any one or combination of determining the recommendation to modify the CSI reporting timing including a recommendation to initiate an aperiodic or semi-persistent CSI report, or change a reporting period of periodic or semi-persistent CSI reporting. This aspect enables the processor 500 to request updated channel information from the network node when the current precoder is outdated. Additionally, or alternatively, the processor 500 may be configured to or operable to support any one or combination of estimating an unprecoded downlink channel based on a CSI-RS, computing a first downlink channel based on the unprecoded downlink channel estimated during a CSI reporting phase and a precoder selected by the UE during the CSI reporting phase, computing a second downlink channel based on the received DMRS symbols, and determining the metric based on a similarity between the first downlink channel and the second downlink channel. This aspect enables the processor 500 to compute a similarity metric that indicates the degree of alignment between the expected effective channel and the actual effective channel. Additionally, or alternatively, the processor 500 may be configured to or operable to support any one or combination of transmitting the feedback message in response to the metric satisfying a threshold condition. This aspect enables event-based transmission of the feedback message to reduce uplink overhead while still enabling the network node to respond to changing channel conditions.

Additionally, or alternatively, the processor 500 may be configured to or operable to support at least one controller (e.g., the controller 502) coupled with at least one memory (e.g., the memory 504) and configured to cause the processor to receive, from a UE, a CSI report including an indication of a recommended precoder based on a downlink channel estimated by the UE, transmit, to the UE, a configuration for downlink transmission, the configuration including a DMRS pattern for a PDSCH, transmit, to the UE, a PDSCH transmission including data symbols and DMRS symbols precoded using a transmit precoder, where the transmit precoder is selected based on the recommended precoder, and receive, from the UE, a feedback message including a metric indicative of a suitability of the DMRS pattern for estimation of a downlink channel or an alignment between the transmit precoder and a wireless channel between the NE and the UE, or a recommendation to modify the DMRS pattern or a CSI reporting timing. In this manner, the processor 500 enables dynamic adaptation of DMRS patterns and CSI reporting timing based on direct feedback from the UE regarding channel estimation quality and precoder alignment.

Additionally, or alternatively, the processor 500 may be configured to or operable to support any one or combination of initiating an aperiodic or semi-persistent CSI report, or changing a reporting period of periodic or semi-persistent CSI reporting. This aspect enables the processor 500 to obtain updated precoder recommendations from the UE when the feedback message indicates precoder misalignment or channel aging. Additionally, or alternatively, the processor 500 may be configured to or operable to support any one or combination of the recommendation to modify the DMRS pattern including a recommendation to increase a density of the DMRS symbols in the DMRS pattern, decrease the density of the DMRS symbols in the DMRS pattern, or select a different DMRS pattern from a set of DMRS patterns. This aspect enables the processor 500 to adapt DMRS overhead based on actual channel estimation requirements indicated by the UE.

Additionally, or alternatively, the processor 500 may be configured to or operable to support any one or combination of transmitting, to the UE, an indication of an updated DMRS pattern in a DCI message. This aspect enables rapid signaling of DMRS pattern changes without requiring RRC reconfiguration. Additionally, or alternatively, the processor 500 may be configured to or operable to support any one or combination of transmitting, to the UE, a set of DMRS patterns, each DMRS pattern associated with a respective identifier, where the indication of the updated DMRS pattern includes the respective identifier corresponding to the updated DMRS pattern. This aspect enables efficient signaling of DMRS pattern changes by referencing preconfigured patterns via identifiers. Additionally, or alternatively, the processor 500 may be configured to or operable to support any one or combination of the CSI report indicating one or more eigenvalues associated with the recommended precoder. This aspect enables the processor 500 to separate the effects of channel change from precoder mismatch when processing the feedback message from the UE.

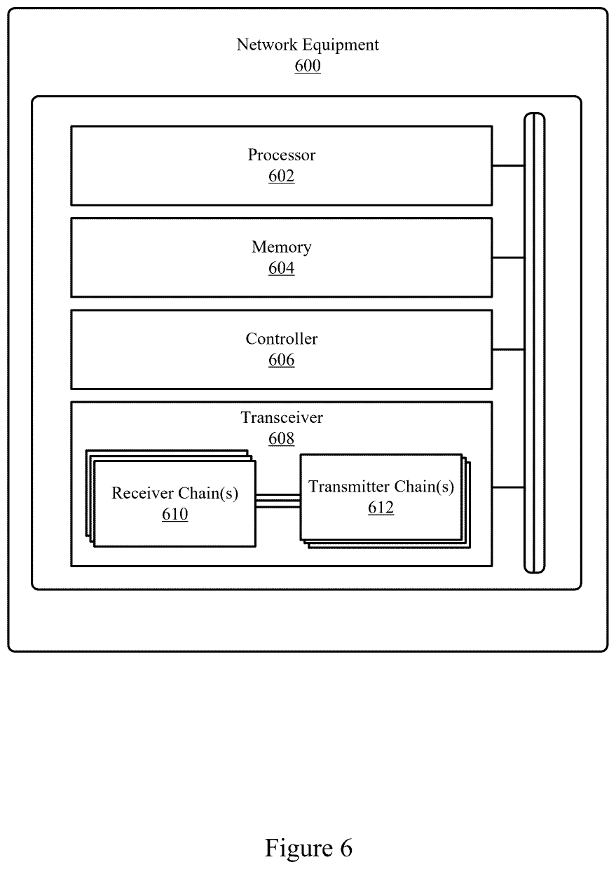

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for receiving, from a UE, a CSI report including an indication of a recommended precoder based on a downlink channel estimated by the UE, transmitting, to the UE, a configuration for downlink transmission, the configuration including a DMRS pattern for a PDSCH, transmitting, to the UE, a PDSCH transmission including data symbols and DMRS symbols precoded using a transmit precoder, where the transmit precoder is selected based on the recommended precoder, and receiving, from the UE, a feedback message including at least one of a metric indicative of at least one of a suitability of the DMRS pattern for estimation of a downlink channel or an alignment between the transmit precoder and a wireless channel between the NE and the UE, or a recommendation to modify at least one of the DMRS pattern or a CSI reporting timing. In this manner, the NE 600 enables dynamic adaptation of DMRS patterns and CSI reporting timing based on direct feedback from the UE regarding channel estimation quality and precoder alignment.

Additionally, or alternatively, the NE 600 may be configured to support any one or combination of the recommendation to modify the CSI reporting timing including at least one of initiating an aperiodic or semi-persistent CSI report, or changing a reporting period of periodic or semi-persistent CSI reporting. This aspect enables the NE 600 to obtain updated precoder recommendations from the UE when the feedback message indicates precoder misalignment or channel aging. Additionally, or alternatively, the NE 600 may be configured to support any one or combination of the recommendation to modify the DMRS pattern including a recommendation to at least one of increase a density of the DMRS symbols in the DMRS pattern, decrease the density of the DMRS symbols in the DMRS pattern, or select a different DMRS pattern from a set of DMRS patterns. This aspect enables the NE 600 to adapt DMRS overhead based on actual channel estimation requirements indicated by the UE.

Additionally, or alternatively, the NE 600 may be configured to support any one or combination of transmitting, to the UE, an indication of an updated DMRS pattern in a DCI message. This aspect enables rapid signaling of DMRS pattern changes without requiring RRC reconfiguration. Additionally, or alternatively, the NE 600 may be configured to support any one or combination of transmitting, to the UE, a set of DMRS patterns, each DMRS pattern associated with a respective identifier, where the indication of the updated DMRS pattern includes the respective identifier corresponding to the updated DMRS pattern. This aspect enables efficient signaling of DMRS pattern changes by referencing preconfigured patterns via identifiers. Additionally, or alternatively, the NE 600 may be configured to support any one or combination of the CSI report indicating one or more eigenvalues associated with the recommended precoder. This aspect enables the NE 600 to separate the effects of channel change from precoder mismatch when processing the feedback message from the UE.

Additionally, or alternatively, the NE 600 may support at least one memory (e.g., the memory 604) and at least one processor (e.g., the processor 602) coupled with the at least one memory and configured to cause the NE 600 to receive, from a UE, a CSI report including an indication of a recommended precoder based on a downlink channel estimated by the UE, transmit, to the UE, a configuration for downlink transmission, the configuration including a DMRS pattern for a PDSCH, transmit, to the UE, a PDSCH transmission including data symbols and DMRS symbols precoded using a transmit precoder, where the transmit precoder is selected based on the recommended precoder, and receive, from the UE, a feedback message including at least one of a metric indicative of at least one of a suitability of the DMRS pattern for estimation of a downlink channel or an alignment between the transmit precoder and a wireless channel between the NE and the UE, or a recommendation to modify at least one of the DMRS pattern or a CSI reporting timing. In this manner, the NE 600 provides closed-loop adaptation of DMRS patterns and CSI reporting timing by receiving direct feedback from the UE regarding channel estimation quality and precoder alignment.

Additionally, or alternatively, the NE 600 may be configured to support any one or combination of the recommendation to modify the CSI reporting timing including at least one of initiating an aperiodic or semi-persistent CSI report, or changing a reporting period of periodic or semi-persistent CSI reporting. This aspect enables the NE 600 to request updated channel information from the UE when precoder misalignment or channel aging is indicated. Additionally, or alternatively, the NE 600 may be configured to support any one or combination of the recommendation to modify the DMRS pattern including a recommendation to at least one of increase a density of the DMRS symbols in the DMRS pattern, decrease the density of the DMRS symbols in the DMRS pattern, or select a different DMRS pattern from a set of DMRS patterns. This aspect enables the NE 600 to dynamically adjust DMRS overhead based on channel estimation requirements reported by the UE.

Additionally, or alternatively, the NE 600 may be configured to support any one or combination of transmitting, to the UE, an indication of an updated DMRS pattern in a DCI message. This aspect enables the NE 600 to signal DMRS pattern changes via dynamic control signaling without requiring RRC reconfiguration. Additionally, or alternatively, the NE 600 may be configured to support any one or combination of transmitting, to the UE, a set of DMRS patterns, each DMRS pattern associated with a respective identifier, where the indication of the updated DMRS pattern includes the respective identifier corresponding to the updated DMRS pattern. This aspect enables the NE 600 to preconfigure multiple DMRS patterns and signal pattern changes by referencing identifiers. Additionally, or alternatively, the NE 600 may be configured to support any one or combination of the CSI report indicating one or more eigenvalues associated with the recommended precoder. This aspect enables the NE 600 to compute the expected performance based on the applied precoder and the recommended precoder to distinguish between channel aging and precoder mismatch.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., an LNA) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

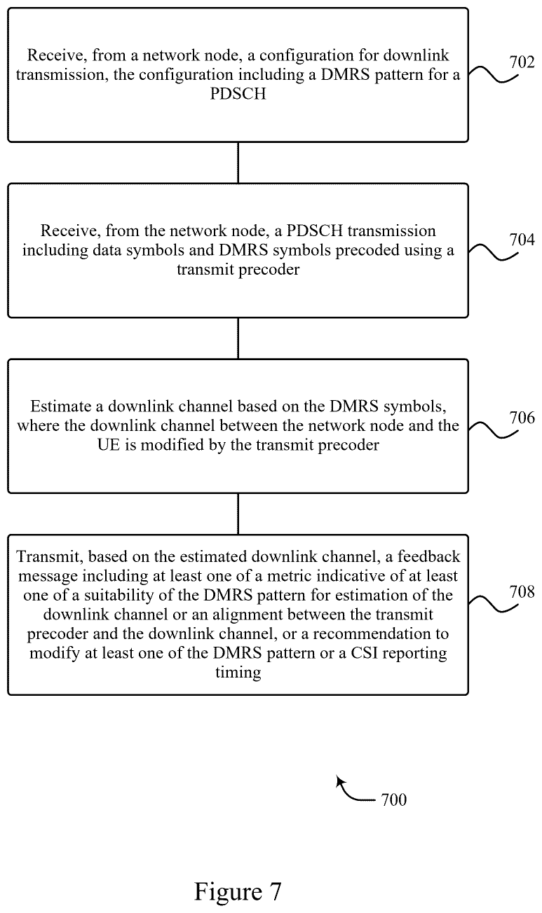

FIG. 7 illustrates a flowchart of a method 700 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 702, the method may include receiving, from a network node, a configuration for downlink transmission, the configuration including a DMRS pattern for a PDSCH. The operations of 702 may be performed in accordance with examples as described herein. In some implementations, aspects of the operations of 702 may be performed by a UE as described with reference to FIG. 4.

At 704, the method may include receiving, from the network node, a PDSCH transmission including data symbols and DMRS symbols precoded using a transmit precoder. The operations of 704 may be performed in accordance with examples as described herein. In some implementations, aspects of the operations of 704 may be performed by a UE as described with reference to FIG. 4.

At 706, the method may include estimating a downlink channel based on the DMRS symbols, where the downlink channel between the network node and the UE is modified by the transmit precoder. The operations of 706 may be performed in accordance with examples as described herein. In some implementations, aspects of the operations of 706 may be performed a UE as described with reference to FIG. 4.

At 708, the method may include transmitting, based on the estimated downlink channel, a feedback message including at least one of a metric indicative of at least one of a suitability of the DMRS pattern for estimation of the downlink channel or an alignment between the transmit precoder and the downlink channel, or a recommendation to modify at least one of the DMRS pattern or a CSI reporting timing. The operations of 708 may be performed in accordance with examples as described herein. In some implementations, aspects of the operations of 708 may be performed a UE as described with reference to FIG. 4.

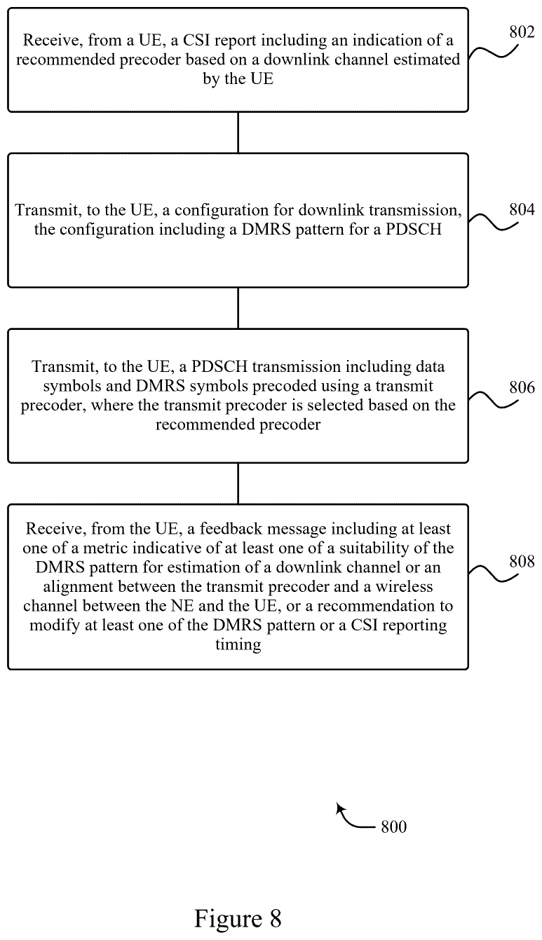

FIG. 8 illustrates a flowchart of a method 800 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include receiving, from a UE, a CSI report including an indication of a recommended precoder based on a downlink channel estimated by the UE. The operations of 802 may be performed in accordance with examples as described herein. In some implementations, aspects of the operations of 802 may be performed by an NE as described with reference to FIG. 6.

At 804, the method may include transmitting, to the UE, a configuration for downlink transmission, the configuration including a DMRS pattern for a PDSCH. The operations of 804 may be performed in accordance with examples as described herein. In some implementations, aspects of the operations of 804 may be performed by an NE as described with reference to FIG. 6.

At 806, the method may include transmitting, to the UE, a PDSCH transmission including data symbols and DMRS symbols precoded using a transmit precoder, where the transmit precoder is selected based on the recommended precoder. The operations of 806 may be performed in accordance with examples as described herein. In some implementations, aspects of the operations of 806 may be performed an NE as described with reference to FIG. 6.

At 808, the method may include receiving, from the UE, a feedback message including at least one of a metric indicative of at least one of a suitability of the DMRS pattern for estimation of a downlink channel or an alignment between the transmit precoder and a wireless channel between the NE and the UE, or a recommendation to modify at least one of the DMRS pattern or a CSI reporting timing. The operations of 808 may be performed in accordance with examples as described herein. In some implementations, aspects of the operations of 808 may be performed an NE as described with reference to FIG. 6.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive, from a network node, a configuration for downlink transmission, the configuration including a demodulation reference signal (DMRS) pattern for a physical downlink shared channel (PDSCH);
receive, from the network node, a PDSCH transmission comprising data symbols and DMRS symbols precoded using a transmit precoder;
estimate a downlink channel based at least in part on the DMRS symbols, wherein the downlink channel between the network node and the UE is modified by the transmit precoder; and
transmit, based at least in part on the estimated downlink channel, a feedback message including at least one of:
a metric indicative of at least one of a suitability of the DMRS pattern for estimation of the downlink channel or an alignment between the transmit precoder and the downlink channel, or
a recommendation to modify at least one of the DMRS pattern or a channel state information (CSI) reporting timing.

2. The UE of claim 1, wherein the at least one processor is further operable to cause the UE to:
receive, from the network node, a plurality of DMRS patterns, each DMRS pattern associated with a respective identifier; and
receive, from the network node, an indication of the respective identifier corresponding to the DMRS pattern to be used for the PDSCH transmission.

3. The UE of claim 1, wherein the at least one processor is operable to cause the UE to generate, using an artificial intelligence model, a confidence value representing an accuracy of the estimated downlink channel, wherein the metric indicates the confidence value.

4. The UE of claim 1, wherein the recommendation to modify the DMRS pattern is based at least in part on a comparison of the metric to a threshold.

5. The UE of claim 1, wherein the at least one processor is operable to cause the UE to:
measure the downlink channel at one or more REs corresponding to the DMRS symbols;
interpolate the downlink channel across one or more REs of the PDSCH transmission; and
compute the metric based at least in part on a difference between the interpolated downlink channel at the one or more REs of the DMRS symbols and the measured downlink channel.

6. The UE of claim 1, wherein the at least one processor is operable to cause the UE to:
estimate an unprecoded downlink channel based at least in part on a channel state information reference signal (CSI-RS); and
determine the recommendation to modify the DMRS pattern based at least in part on channel variation characteristics of the unprecoded downlink channel.

7. The UE of claim 1, wherein the at least one processor is operable to cause the UE to:
estimate the downlink channel for a first RB and a second RB, the second RB adjacent to the first RB in time or frequency; and
determine the recommendation to modify the DMRS pattern based at least in part on a variation between the downlink channel for the first RB and the downlink channel for the second RB.

8. The UE of claim 1, wherein the at least one processor is operable to cause the UE to:
compute an actual received power based at least in part on the DMRS symbols received at one or more REs of the PDSCH transmission;
compute an expected received power based at least in part on an unprecoded downlink channel estimated during a CSI reporting phase and a precoder selected by the UE during the CSI reporting phase; and
determine the metric based at least in part on the actual received power and the expected received power.

9. The UE of claim 8, wherein the recommendation to modify the CSI reporting timing is based at least in part on a difference between the actual received power and the expected received power exceeding a threshold.

10. The UE of claim 1, wherein the recommendation to modify the CSI reporting timing comprises a recommendation to at least one of:
initiate an aperiodic or semi-persistent CSI report; or
change a reporting period of periodic or semi-persistent CSI reporting.

11. The UE of claim 1, wherein the at least one processor is operable to cause the UE to:
estimate an unprecoded downlink channel based at least in part on a channel state information reference signal (CSI-RS);
compute a first downlink channel based at least in part on the unprecoded downlink channel estimated during a CSI reporting phase and a precoder selected by the UE during the CSI reporting phase;
compute a second downlink channel based at least in part on the received DMRS symbols; and
determine the metric based at least in part on a similarity between the first downlink channel and the second downlink channel.

12. The UE of claim 1, wherein the at least one processor is operable to cause the UE to transmit the feedback message in response to the metric satisfying a threshold condition.

13. A network entity (NE) for wireless communication, comprising:
at least one memory; and
at least one processor coupled with the at least one memory and operable to cause the NE to:
receive, from a user equipment (UE), a channel state information (CSI) report including an indication of a recommended precoder based at least in part on a downlink channel estimated by the UE;
transmit, to the UE, a configuration for downlink transmission, the configuration including a demodulation reference signal (DMRS) pattern for a physical downlink shared channel (PDSCH);
transmit, to the UE, a PDSCH transmission comprising data symbols and DMRS symbols precoded using a transmit precoder, wherein the transmit precoder is selected based at least in part on the recommended precoder; and
receive, from the UE, a feedback message including at least one of:
a metric indicative of at least one of a suitability of the DMRS pattern for estimation of a downlink channel or an alignment between the transmit precoder and a wireless channel between the NE and the UE; or
a recommendation to modify at least one of the DMRS pattern or a CSI reporting timing.

14. The NE of claim 13, wherein the recommendation to modify the CSI reporting timing comprises the at least one processor operable to cause the NE to at least one of:
initiate an aperiodic or semi-persistent CSI report; or
change a reporting period of periodic or semi-persistent CSI reporting.

15. The NE of claim 13, wherein the recommendation to modify the DMRS pattern comprises a recommendation to at least one of:
increase a density of the DMRS symbols in the DMRS pattern;
decrease the density of the DMRS symbols in the DMRS pattern; or
select a different DMRS pattern from a plurality of DMRS patterns.

16. The NE of claim 13, wherein the at least one processor is operable to cause the NE to transmit, to the UE, an indication of an updated DMRS pattern in a downlink control information (DCI) message.

17. The NE of claim 16, wherein the at least one processor is operable to cause the NE to transmit, to the UE, a plurality of DMRS patterns, each DMRS pattern associated with a respective identifier, wherein the indication of the updated DMRS pattern comprises the respective identifier corresponding to the updated DMRS pattern.

18. The NE of claim 13, wherein the CSI report indicates one or more eigenvalues associated with the recommended precoder.

19. A method performed by a user equipment (UE), the method comprising:
receiving, from a network node, a configuration for downlink transmission, the configuration including a demodulation reference signal (DMRS) pattern for a physical downlink shared channel (PDSCH);
receiving, from the network node, a PDSCH transmission comprising data symbols and DMRS symbols precoded using a transmit precoder;
estimating a downlink channel based at least in part on the DMRS symbols, wherein the downlink channel between the network node and the UE is modified by the transmit precoder; and
transmitting, based at least in part on the estimated downlink channel, a feedback message including at least one of:
a metric indicative of at least one of a suitability of the DMRS pattern for estimation of the downlink channel or an alignment between the transmit precoder and the downlink channel, or
a recommendation to modify at least one of the DMRS pattern or a channel state information (CSI) reporting timing.

20. A method performed by a network entity (NE), the method comprising:
receiving, from a user equipment (UE), a channel state information (CSI) report including an indication of a recommended precoder based at least in part on a downlink channel estimated by the UE;
transmitting, to the UE, a configuration for downlink transmission, the configuration including a demodulation reference signal (DMRS) pattern for a physical downlink shared channel (PDSCH);
transmitting, to the UE, a PDSCH transmission comprising data symbols and DMRS symbols precoded using a transmit precoder, wherein the transmit precoder is selected based at least in part on the recommended precoder; and
receiving, from the UE, a feedback message including at least one of:
a metric indicative of at least one of a suitability of the DMRS pattern for estimation of a downlink channel or an alignment between the transmit precoder and a wireless channel between the NE and the UE; or
a recommendation to modify at least one of the DMRS pattern or a CSI reporting timing.
